(19) United States
(12) Patent Application Publication
(10) Pub. No.: US 2015/0205053 A1
(43) Pub. Date: Jul. 23, 2015

(54) Multi-core Fiber Connection Member, Structure for Connecting Multi-Core Fibers, and Method for Connecting Multi-Core Fibers

(71) Applicant: KONICA MINOLTA, INC., Chiyoda-ku (JP)

(72) Inventors: Kentaro Aoki, Hachioji-shi (JP); Akiko Hara, Hachioji-shi (JP); Masashi Saito, Koganei-shi (JP)

(21) Appl. No.: 14/419,190

(22) PCT Filed: Jul. 26, 2013
(86) PCT No.: PCT/JP2013/070327

§ 371 Date: Feb. 2, 2015

(30) Foreign Application Priority Data
Aug. 1, 2012 (JP) 2012-171259

(51) Int. Cl. G02B 6/38

(52) U.S. Cl. CPC G02B 6/3825; G02B 6/3853

(57) ABSTRACT

A multi-core optical fiber connecting member includes a first resin unit and a second resin unit. The first resin unit abuts on first cores on end surfaces of a first multi-core optical fiber and a second multi-core optical fiber. The first resin unit transmits light from the first core of the first multi-core optical fiber to guide the light to the first core of the second multi-core optical fiber. The second resin unit abuts on second cores on the end surfaces of the first multi-core optical fiber and the second multi-core optical fiber. The second resin unit transmits light from the second core of the first multi-core optical fiber to guide the light to the second core of the second multi-core optical fiber. The first and second resin units each have a thickness corresponding to the shape of each end surface of the first and second multi-core optical fibers.

### TECHNICAL FIELD

The embodiments of the present invention relate to multi-core optical fiber connecting members, multi-core optical fiber connection structures, and multi-core optical fiber connection methods.

### BACKGROUND ART

In optical communication and the like, optical plugs using optical fibers are used in order to secure light transmission lines. Two optical fibers are connected to each other by connecting the optical plugs through an adapter. As the result, the light transmission lines connecting the two optical fibers can be formed.

Types of the optical fiber used for the optical plug includes single-core optical fibers and multi-core optical fibers. The single-core optical fiber is an optical fiber in which a core is provided in a clad. On the other hand, the multi-core optical fiber is an optical fiber in which a plurality of cores is provided in a clad (see Patent Documents 1 and 2). In the optical plug, the optical fiber is inserted into a ferrule.

When the optical plugs are connected to each other, light loss may occur if any space is formed between the optical fibers (end surfaces of cores). This light loss is caused by Fresnel reflection at the end surfaces of the cores or the like. Hereinafter, the light loss may be described as a “connection loss”.

In order to reduce such the connection loss, a method called Physical Contact in which optical fibers (end surfaces of cores) are directly connected to each other may be used (see Patent Document 3). For example, the Physical Contact is carried out as follows. Firstly, each end surface of a single-core optical fiber held by a ferrule is polished along with the end surface of the ferrule into a convex spherical surface. The end surfaces of the cores of the single fibers are then brought into contact with each other. After that, each of the ferrules is pressed so as to elastically deform the single-core optical fibers and the ferrules therearound. This elastic deformation causes the end surfaces of the cores to tightly connect to each other.

### PRIOR ART DOCUMENT

### Patent Documents

[Patent Document 1] Japanese Unexamined Patent Application Publication No. Hei-10-104443
[Patent Document 2] Japanese Unexamined Patent Application Publication No. Hei-8-119656
[Patent Document 3] Japanese Unexamined Patent Application Publication No. Hei-5-39445

### SUMMARY OF THE INVENTION

### Problems to be Solved by the Invention

Here, it is described the case that optical plugs using multi-core optical fibers are connected by Physical Contact with reference to FIG. 20. FIG. 20 is a cross-sectional view of a multi-core optical fiber MF1 (MF2) and a ferrule F1 (F2) in the axial direction. Further, in FIG. 20, tip end parts of the multi-core optical fiber MF1 (MF2) and the ferrule F1 (F2) are enlarged to show.

The end surfaces of the multi-core optical fibers MF1 and MF2 may be polished into spherical. In this case, an end face of a core Cc1 is positioned at the vertex of the end surface (convex spherical surface) of the multi-core optical fiber MF1. Similarly, an end face of a core Cc2 is positioned at the vertex of the end surface (convex spherical surface) of the multi-core optical fiber MF2. As shown in FIG. 20, when the polished end surfaces of the multi-core optical fibers MF1 and MF2 are connected to each other, the end surface of the core Cc1 of the multi-core optical fiber MF1 and the end surface of the core Cc2 of the multi-core optical fiber MF2 are connected in close contact. Thus, connection loss hardly occurs between the core Cc1 and the core Cc2.

However, cores Ca1 are present in the vicinity of the core Cc1. Similarly, cores Ca2 are also present in the vicinity of the core Cc2. Therefore, a space S is formed between the core Ca1 and the Ca2 in the state that the end surfaces of cores Cc are connected to each other. That is, since the end surfaces of the cores Ca cannot be in close contact with each other, the connection between the core Ca1 and the core Ca2 is not sufficient. Thus, a problem arises that a connection loss is likely to occur between the core Ca1 and the core Ca2. Broken line arrows in FIG. 20 indicate that the connection loss occurs. Curvatures of the convex spherical surfaces, and the like, in FIG. 20 are exaggeratedly illustrated so that the above problem can be easily understood.

Further, in the case that the multi-core optical fibers are connected to each other by Physical Contact, works including adjusting pressure applied to the ferrules, and the like, become complex. Therefore, another problem arises that it is difficult to precisely connect end surfaces of a plurality of cores to each other.

The embodiments of the present invention are intended to solve the above-described problems. That is, the object is to provide a technique to reduce a light connection loss of multi-core optical fibers with a simple structure.

### Means of Solving the Problems

To achieve the above objects, a multi-core optical fiber connecting member as set forth in claim 1 includes a first resin unit and a second resin unit. The first resin unit is in contact with a first core on an end surface of a first multi-core optical fiber and a first core on an end surface of a second multi-core optical fiber. The first resin unit transmits light from the first core of the first multi-core optical fiber therethrough and guides the light to the first core of the second multi-core optical fiber. The second resin unit is in contact with a second core on the end surface of the first multi-core optical fiber and a second core on the end surface of the second multi-core optical fiber. The second resin unit transmits light from the second core of the first multi-core optical fiber therethrough and guides the light to the second core of the second multi-core optical fiber. Each of the first resin unit and the second resin unit has a thickness corresponding to the shape of the end surface of each of the first multi-core optical fiber and the second multi-core optical fiber.

The multi-core optical fiber connecting member as set forth in claim 2 connects the first multi-core optical fiber and the second multi-core optical fiber each having the end surface processed into a spherical surface. The first resin unit and the second resin unit have different thicknesses.

The multi-core optical fiber connecting member as set forth in claim 3 connects the first multi-core optical fiber and the second multi-core optical fiber, in which the first core is a single core arranged substantially in the center position, and the second core includes one or more cores arranged in positions different from the center position. The thickness of the first resin unit is less than that of the second resin unit.

In the multi-core optical fiber connecting member as set forth in claim 4, the second resin unit is formed in an annular form to surround the first resin unit.

The multi-core optical fiber connecting member as set forth in claim 5 connects the first multi-core optical fiber and the second multi-core optical fiber each having a plurality of the second cores. The first resin unit includes a first lens unit in contact with the first core of each of the first multi-core optical fiber and the second multi-core fiber. The second resin unit includes a plurality of second lens units, the number of which is the same as the number of the second cores. The second lens units are each in contact with corresponding one of the second cores of each of the first multi-core optical fiber and the second multi-core optical fiber.

In the multi-core optical fiber connecting member as set forth in claim 6, the second lens units are arranged on a concentric circle with the first lens unit as the center.

The multi-core optical fiber connecting member as set forth in claim 7 connects the end surfaces of the first multi-core optical fiber and the second multi-core optical fiber processed into a plane. The first resin unit and the second resin unit have the same thickness.

A connecting structure of multi-core optical fibers as set forth in claim 8 includes the first multi-core optical fiber and the second multi-core optical fiber of any one of claims 1 to 7. The connecting structure further includes a ferrule in which the multi-core optical fiber is inserted. The connecting structure further includes a sleeve in which the ferrule is inserted. The connecting structure still further includes the multi-core optical fiber connecting member of any one of claims 1 to 7. The sleeve is provided with an insertion hole, in which the multi-core optical fiber connecting member is inserted in a direction orthogonal to each of the insertion directions of the first multi-core optical fiber and the second multi-core optical fiber.

A connection method of multi-core optical fibers as set forth in claim 9 includes an arrangement step for arranging a multi-core optical fiber connecting member, a connection step for connecting the multi-core optical fibers to each other, and a position adjustment step. The arrangement step includes arranging the multi-core optical fiber connecting member of any one of claims 1, 4, and 7 in an insertion hole of a sleeve. The insertion hole is provided in a direction orthogonal to each of the insertion directions of a first multi-core optical fiber and a second multi-core optical fiber. The connection step includes inserting the first multi-core optical fiber and the second multi-core optical fiber each inserted in a ferrule from both ends of the sleeve, and connecting the multi-core optical fibers to each other through the multi-core optical fiber connecting member. The position adjustment step includes adjusting the positions of the multi-core optical fibers.

A connection method of multi-core optical fibers as set forth in claim 10 includes an arrangement step for arranging a multi-core optical fiber connecting member, a connection step for connecting the multi-core optical fibers to each other, a first position adjustment step, and a second position adjustment step. The arrangement step includes arranging the multi-core optical fiber connecting member of any one of claims 1, 5, and 6 in an insertion hole of a sleeve. The insertion hole is provided in a direction orthogonal to each of the insertion directions of a first multi-core optical fiber and a second multi-core optical fiber. The connection step includes inserting the first multi-core optical fiber and the second multi-core optical fiber each inserted in a ferrule from both ends of the sleeve, and connecting the multi-core optical fibers to each other through the multi-core optical fiber connecting member. The first position adjustment step includes adjusting positions of the first multi-core optical fiber and the multi-core optical fiber connecting member. The second position adjustment step includes adjusting positions of the second multi-core optical fiber and the multi-core optical fiber connecting member.

### Effect of the Invention

According to the present invention, multi-core optical fibers are connected to each other through a multi-core optical fiber connecting member corresponding to the shapes of the end surfaces of the multi-core optical fibers. With such the configuration, it becomes possible to reduce the light connection loss in connection.

### BRIEF DESCRIPTION OF THE DRAWINGS

FIG. 1 is a diagram illustrating a common multi-core optical fiber in embodiments.

FIG. 2A is a diagram illustrating a multi-core optical fiber according to a first embodiment.

FIG. 2B is a diagram illustrating a ferrule according to the first embodiment.

FIG. 2C is a diagram illustrating the multi-core optical fiber according to the first embodiment.

FIG. 2D is a diagram illustrating the multi-core optical fiber according to the first embodiment.

FIG. 3A is a diagram illustrating a connecting member according to the first embodiment.

FIG. 3B is a diagram illustrating the connecting member according to the first embodiment.

FIG. 4A is a diagram illustrating a connecting unit according to the first embodiment.

FIG. 4B is a diagram illustrating the connecting unit according to the first embodiment.

FIG. 5A is a diagram illustrating a sleeve according to the first embodiment.

FIG. 5B is a diagram illustrating the sleeve according to the first embodiment.

FIG. 5C is a diagram illustrating the sleeve according to the first embodiment.

FIG. 6A is a diagram illustrating a connection structure of the multi-core optical fibers according to the first embodiment.

FIG. 6B is a diagram illustrating the connection structure of the multi-core optical fibers according to the first embodiment.

FIG. 7 is a flowchart illustrating a connection method of the multi-core optical fibers according to the first embodiment.

FIG. 8A is a diagram illustrating a connecting unit according to a modified example of the first embodiment.

FIG. 8B is a diagram illustrating the connecting unit according to the modified example of the first embodiment.

FIG. 9A is a diagram illustrating the connecting unit according to a second embodiment.

FIG. 9B is a diagram illustrating the connecting unit according to the second embodiment.

FIG. 10 is a flowchart illustrating a connection method of the multi-core optical fibers according to the second embodiment.

FIG. 11A is a diagram illustrating a multi-core optical fiber according to a third embodiment.

FIG. 11B is a diagram illustrating the multi-core optical fiber according to the third embodiment.

FIG. 12 is a diagram illustrating a connecting unit according to the third embodiment.

FIG. 13 is a diagram illustrating a connection structure of the multi-core optical fibers according to the third embodiment.

FIG. 14 is a diagram illustrating a multi-core optical fiber according to a modified example 1.

FIG. 15A is a diagram illustrating a connecting unit according to the modified example 1.

FIG. 15B is a diagram illustrating the connecting unit according to the modified example 1.

FIG. 16 is a diagram illustrating a multi-core optical fiber according to a modified example 2.

FIG. 17A is a diagram illustrating a connecting unit according to the modified example 2.

FIG. 17B is a diagram illustrating the connecting unit according to the modified example 2.

FIG. 18 is a diagram illustrating a connecting unit according to a fourth embodiment.

FIG. 19 is a diagram illustrating a connection structure of multi-core optical fibers according to the fourth embodiment.

FIG. 20 is a diagram illustrating a state in which optical plugs using multi-core optical fibers are connected to each other by Physical Contact.

### MODES FOR CARRYING OUT THE INVENTION

### [Configuration of a Multi-Core Optical Fiber]

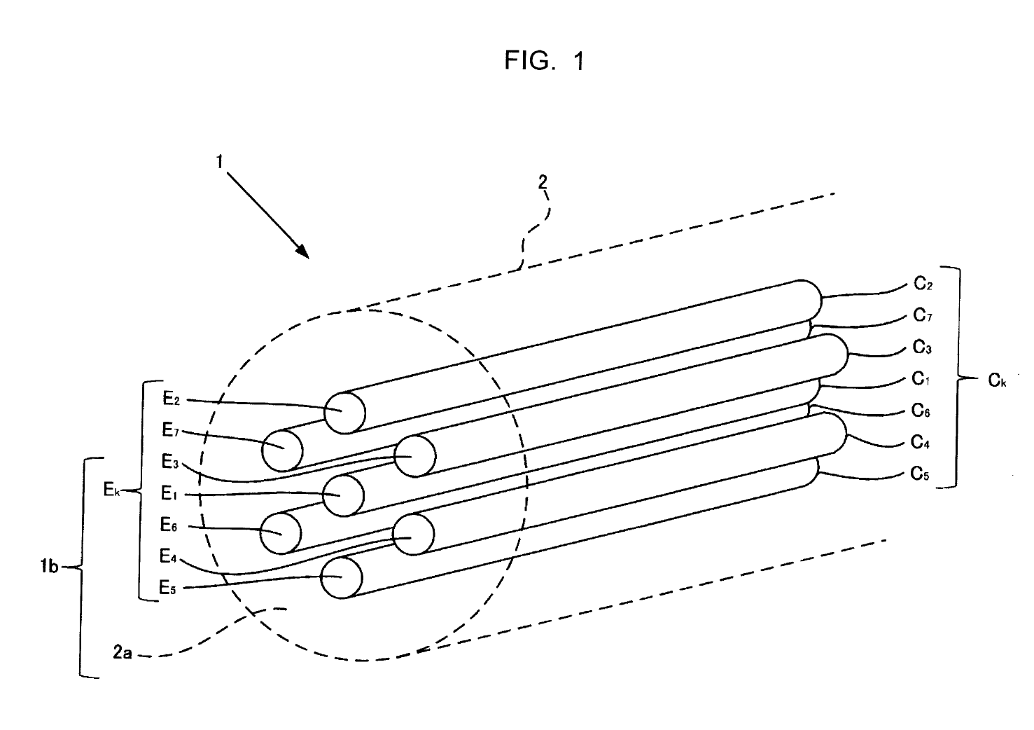

The configuration of a multi-core optical fiber 1 is described with reference to FIG. 1. The multi-core optical fiber is typically a long cylindrical member having flexibility. FIG. 1 is a perspective view of the multi-core optical fiber 1. In FIG. 1, only a tip end part of the multi-core optical fiber 1 is shown.

The multi-core optical fiber 1 is configured with materials having a high light transmittance, such as quarts glass, plastic, and the like. The multi-core optical fiber 1 is configured including a plurality of cores Cₖ (k=1 to n) and a clad 2.

The cores Cₖ are transmission lines for transmitting light from a light source (not shown). Each of the cores Cₖ has an end surface Eₖ (k=1 to n). The end surface Eₖ emits light generated by the light source. The cores Cₖ are configured with materials such as, for example, quarts glass to which germanium oxide (GeO₂) is added, for increasing a refractive index more than that of the clad 2.

In FIG. 1, the multi-core optical fiber 1 having seven cores C₁ to C₇ is shown. The cores C₂ to C₇ are arranged in rotational symmetry with the core C₁ as the center. In the following embodiments, the core C₁ positioned in the center of the multi-core optical fiber 1 is an example of a “first core”. The cores C₂ to C₇ arranged around the core C₁ are examples of a “second core”.

The clad 2 is a member to cover the plurality of cores Cₖ. The clad 2 plays a part for confining the light from the light source in the cores Cₖ. The clad 2 has an end surface 2a. End surfaces Eₖ of the cores Cₖ and the end surface 2a of the clad 2 form the same plane, and form an end surface 1b of the multi-core optical fiber 1. Materials having lower refractive indices than that of the materials of the core Cₖ are used for the materials for the clad 2. For example, in the case that the materials of the cores Cₖ are quarts glass and germanium oxide, quarts glass is used as the materials for the clad 2. In this way, the light from the light source is totally reflected at a boundary surface of the cores Cₖ and the clad 2 by making the refractive index of the cores Cₖ higher than the refractive index of the clad 2. As the result, the light can be transmitted into the cores Cₖ. The cores Cₖ may be configured to have the refractive index set to be increased toward the outside in a radial direction. As the result, the light entered into the cores Cₖ can be transmitted while being refracted therein.

### First Embodiment

### End Surface Shape of the Multi-Core Optical Fiber

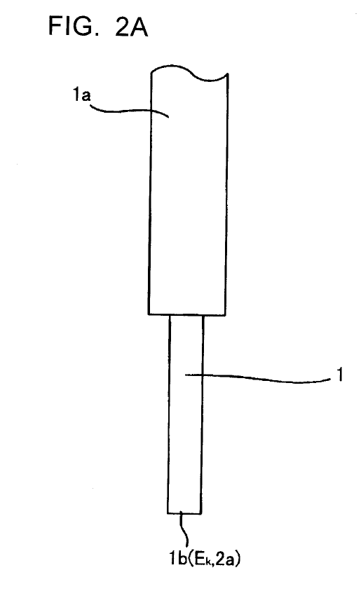

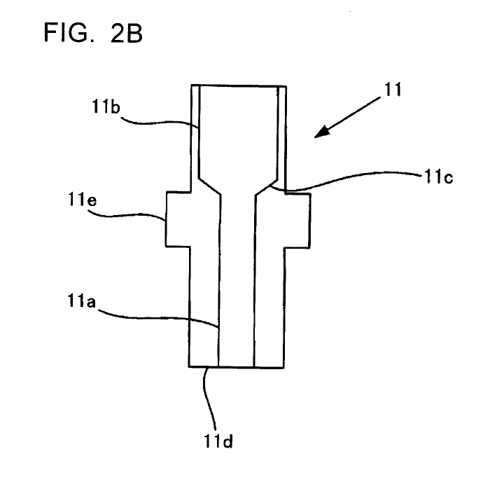

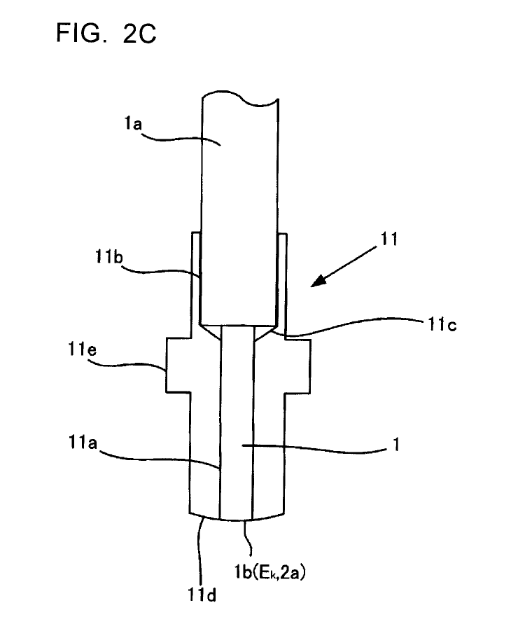

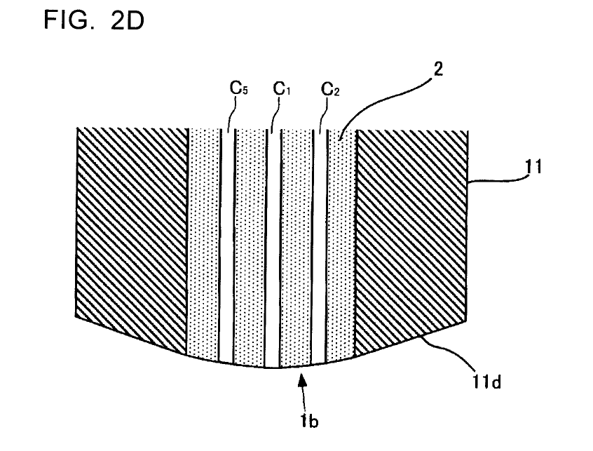

The shape of the end surface of the multi-core optical fiber 1 in the present embodiment is described with reference to FIG. 2A to FIG. 2D. FIG. 2A is a cross-sectional view of the multi-core optical fiber 1 in the axial direction. FIG. 2B is a cross-sectional view of a ferrule 11 in the axial direction. FIG. 2C is a cross-sectional view of the multi-core optical fiber 1 and the ferrule 11 in the axial direction. FIG. 2D is an enlarged diagram illustrating the tip end part of the multi-core optical fiber 1 and the ferrule 11 in the FIG. 2C. In FIG. 2A to FIG. 2D, the diameter of the multi-core optical fiber 1 to that of the ferrule 11 is exaggeratedly illustrated in order to facilitate understanding of the contents of the embodiment. For example, the multi-core optical fiber 1 having a diameter of φ0.15 is practically used for the ferrule 11 having a diameter of φ2.5.

The multi-core optical fiber 1 has the plurality of cores Cₖ in the clad 2, as described above. Further, as shown in FIG. 2A, the multi-core optical fiber 1 is covered with a protective material 1a, such as plastic or the like. The multi-core optical fiber 1 is an example of a “first multi-core optical fiber” or a “second multi-core optical fiber”.

As shown in FIG. 2B, the ferrule 11 is a member formed in a cylindrical form for supporting the multi-core optical fiber 1 having flexibility. The ferrule 11 is made from a material including, for example, glass (quarts glass, borosilicate glass), crystallized glass, stainless material, zirconia (ZrO2), and the like.

A cylindrical space 11a and a space 11b continuous to the space 11a through a tapered surface 11c are provided in the ferrule 11. The space 11b is also formed in a cylindrical form, and the diameter thereof is larger than that of the space 11a. The multi-core optical fiber 1 is inserted into the space 11a. The protective material 1a is inserted into the space 11b. Further, the position of the multi-core optical fiber 1 to the ferrule 11 is determined by that at least one part of the tip end surface of the protective material 1a is abutted against the tapered surface 11c. The multi-core optical fiber 1 and the ferrule 11 are fixed with an adhesive, or the like, in the position-determined state (see FIG. 2C).

An end surface 11d is formed at one end of the ferrule 11. In the state that the multi-core optical fiber 1 is inserted into the ferrule 11, the end surface 1b (the end surfaces Eₖ of the cores Cₖ and the end surface 2a of the clad 2) and the end surface 11d form the same plane (see FIG. 2C).

Further, in the embodiment, the end surface 1b of the multi-core optical fiber 1 in the state shown in FIG. 2A is subjected to spherical surface polishing (see FIG. 2C). Similarly, the end surface 11d of the ferrule 11 in the state shown in FIG. 2B is also subjected to the spherical surface polishing (see FIG. 2C). Those end surfaces as a whole are formed in a curved surface form by the spherical surface polishing. Further, as shown in FIG. 2D, at the end surface to which the spherical surface polishing has been performed, the curved surface (spherical surface) is formed at a predetermined curvature so as to position the center core C₁ at the most projected position. The curvatures of the end surface 1b of the multi-core optical fiber 1 and the end surface 11d of the ferrule 11 in FIG. 2D are exaggeratedly illustrated to facilitate understanding of the contents of the embodiment.

### [About the Connecting Member]

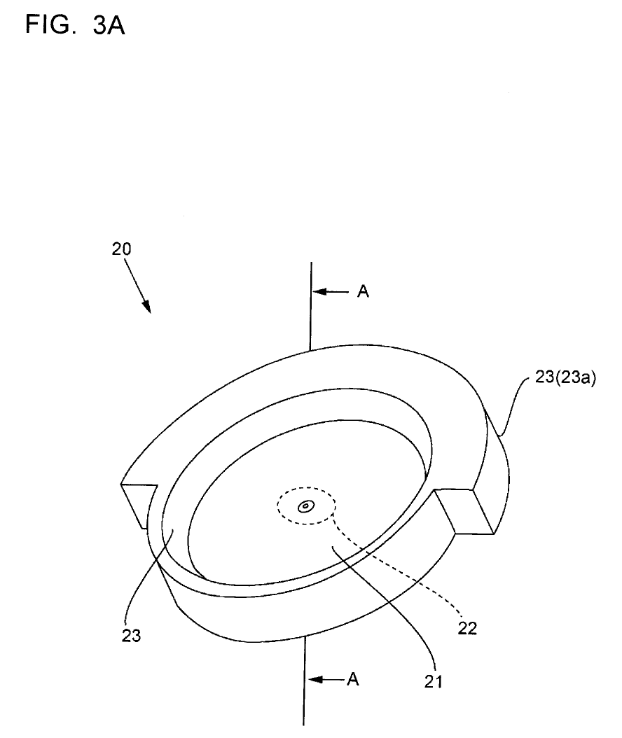

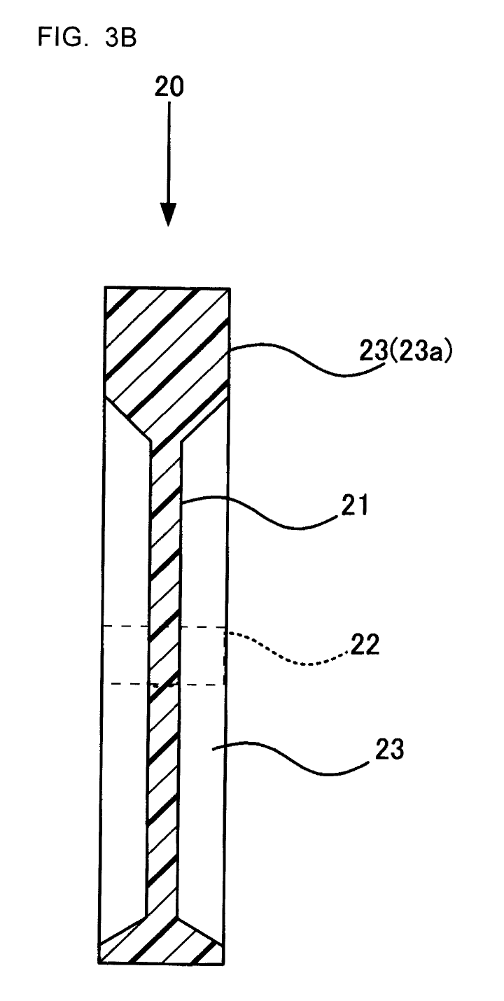

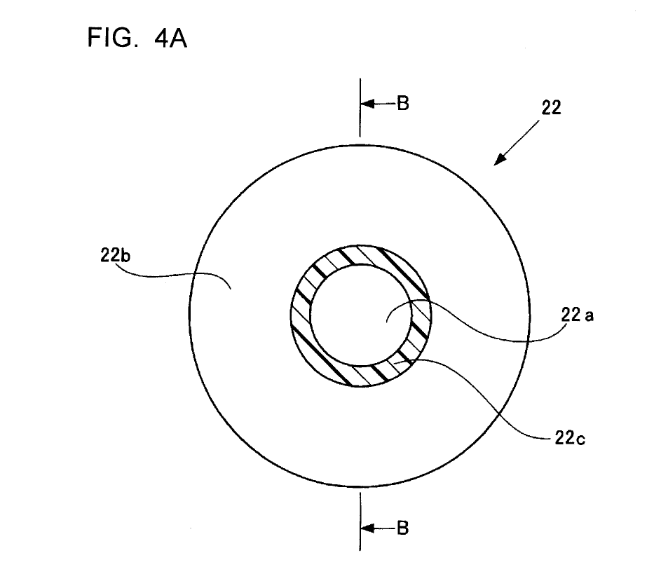

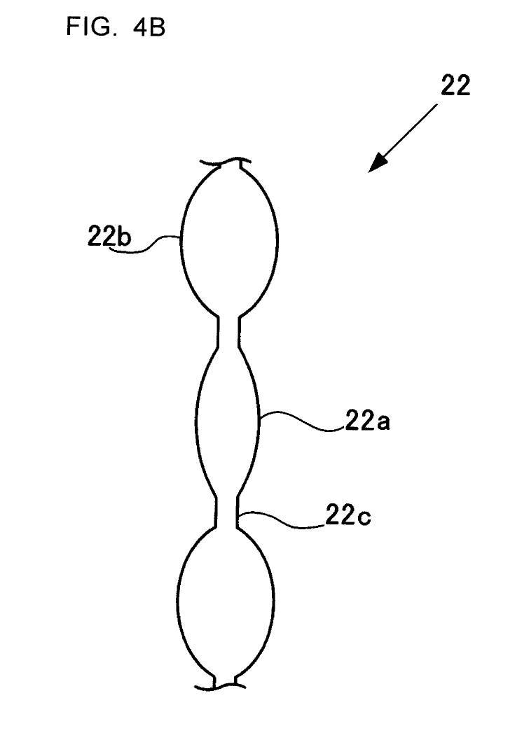

The configuration of a connecting member 20 is described with reference to FIG. 3A to FIG. 4B. The connecting member 20 is arranged between the end surfaces 1b so as to connect two multi-core optical fibers. FIG. 3A is a perspective view of the connecting member 20. FIG. 3B is a cross-sectional view taken along line A-A of FIG. 3A. FIG. 4A is an enlarged front view of a part indicated by a broken line in FIG. 3A. FIG. 4B is a cross-sectional view taken along line B-B of FIG. 4A.

As the connecting member 20, for example, resin materials, such as thermoplastic resin, energy curable resin, and the like, are used. Specifically, as the resin, GA700H or GA700L of UV curable resin (adhesive) manufactured by NTT Advanced Technology Corporation can be used. Taking the durability of the connecting member 20 into consideration, resin having a low elasticity (soft) is preferable. The resin having a low elasticity is, for example, GA700L. Further, as the connecting member 20, in order to reduce the reflection attenuation amount thereof, it is preferable to use resin having the same refractive index as that of the cores Cₖ of the multi-core optical fiber 1.

As shown in FIG. 3A, the connecting member 20 has a circle connecting unit 21, a core abutting portion 22 provided at a part of the connecting unit 21, and a flange 23.

The connecting unit 21 is a plate-like circle part in the connecting member 20. When the multi-core optical fibers are connected to each other through the connecting member 20, the connecting unit 21 abuts to the end surface 11d of the ferrule 11. That is, the connecting unit 21 is formed to have an outer diameter substantially equal to the outer diameter of the end surface 11d of the ferrule 11.

The core abutting portion 22 is provided at a part of the connecting unit 21, and is a part in contact with the multi-core optical fiber 1. In the example of FIG. 3A, the core abutting portion 22 is located substantially at the center of the connecting unit 21. The core abutting portion 22 is formed substantially as large as the outer diameter of the multi-core optical fiber 1. As shown in FIG. 4A and FIG. 4B, the core abutting portion 22 has a first resin unit 22a, a second resin unit 22b, and a groove 22c.

The first resin unit 22a is in contact with the first cores (cores C₁) of the multi-core optical fibers 1. Light from the first core (core C₁) of one of the multi-core optical fibers 1 is guided to the first core (core C₁) of the other one of the multi-core optical fibers 1 through the first resin unit 22a.

As shown in FIG. 4B, the first resin unit 22a in the embodiment has a first surface protruding in a convex curved surface form, and a second surface protruding in a convex curved surface form toward a substantially exactly opposite direction of the first surface. The first surface and the second surface of the first resin unit 22a are formed so as to be gradually thicker toward the protruding direction. Further, the first surface and the second surface of the first resin unit 22a correspond to a first surface and a second surface of the connecting member 20, respectively. Furthermore, the first resin unit 22a is located at a position corresponding to the first cores C₁ of the multi-core optical fibers 1 to be connected through the connecting member 20.

The second resin unit 22b is located at a position corresponding to the second cores C₂ to C₇ of the multi-core optical fibers 1 to be connected through the connecting member 20. In the case that the second cores C₂ to C₇ are arranged so as to surround (be outside) the core C₁ in the multi-core optical fiber 1, the second resin unit 22b is formed so as to surround the first resin unit 22a. That is, the second resin unit 22b is in contact with the second cores (cores C₂ to C₇) of the multi-core optical fiber 1. Light from the second cores (cores C₂ to C₇) of one of the multi-core optical fibers 1 is guided to the second cores (cores C₂ to C₇) corresponding to the other one of the multi-core optical fibers 1 through the second resin unit 22b.

As shown in FIG. 4A, the second resin unit 22b in the embodiment is formed in an annular form so as to surround (be outside) the first resin unit 22a through the groove 22c. Further, in the same manner as the first resin unit 22a, the second resin unit 22b has a first surface protruding in a convex curved surface form and a second surface protruding in a convex curved surface form toward substantially exactly opposite direction of the first surface. The first surface and the second surface of the second resin unit 22b also correspond to the first surface and the second surface of the connecting member 20, respectively.

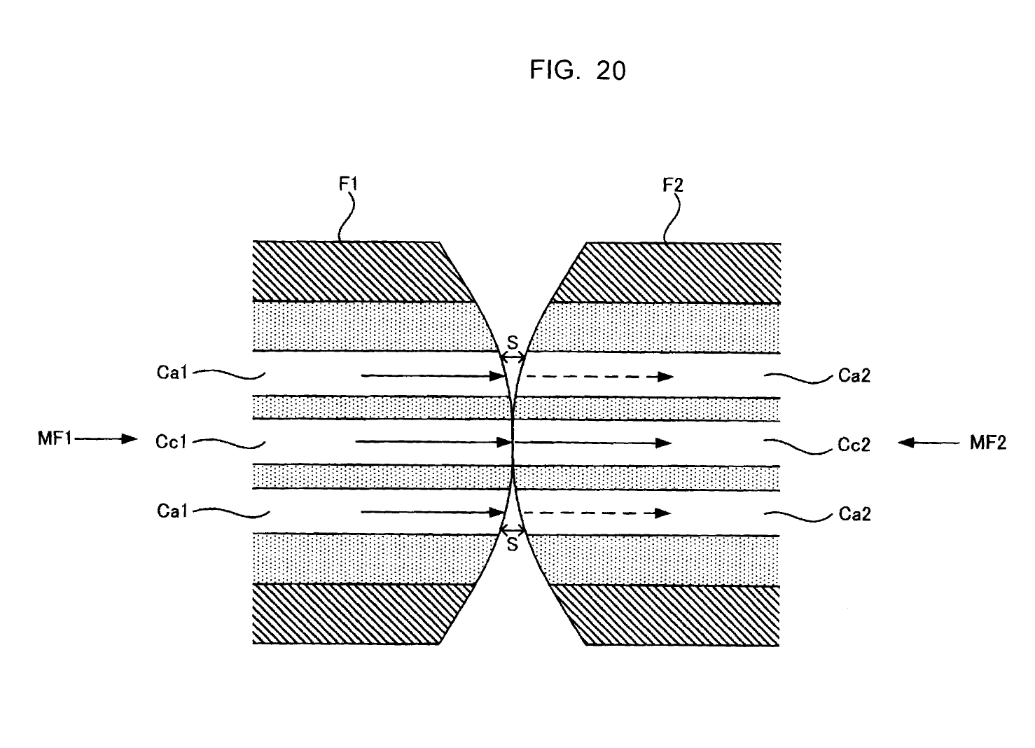

Furthermore, as shown in FIG. 4B, the second resin unit 22b is formed so as to be thicker than the first resin unit 22a. That is, the protruding height of the first resin unit 22a is higher than the height of the protruding part of the second resin unit 22b. For example, the second resin unit 22b is formed to have a height about 40 μm higher than that of the first resin unit 22a. In order to facilitate understanding of the difference in the thickness (height) of the first resin unit 22a and the second resin unit 22b, the height difference is exaggeratedly illustrated in FIG. 4B. It is desirable for the height difference (thickness difference) of the first resin unit 22a and the second resin unit 22b to be made corresponding to the curvature of the end surface 1b of the multi-core optical fiber 1 subjected to the spherical surface polishing. That is, as shown in FIG. 20, the space S becomes larger toward the outer side of the multi-core optical fiber 1 depending on the curvature of the end surface 1b of the multi-core optical fiber 1. It is desirable for the height difference of the first resin unit 22a and the second resin unit 22b to be set at least to fill the space S.

In order to suppress the connection loss, it is desirable for the diameters of the first resin unit 22a and the second resin unit 22b to be formed equal to or larger than that of the core Cₖ.

The flange 23 is provided so as to surround the outer circumference of the connecting unit 21. As shown in FIG. 3A, the flange 23 can also be called an outer circumference of the connecting member 20. The flange 23 protrudes from the outer edges of the both surfaces of the connecting unit 21 toward the substantially exactly opposite direction of each other. Thus, the sum of the length of each protruding part of the flange 23 in the protruding direction is longer than the thickness of the core abutting portion 22, and also longer than the thickness of the connecting unit 21 (see FIG. 3B). A part of the flange 23 in the embodiment (for example, a half periphery of the connecting unit 21) protrudes in the radial direction of the connecting unit 21 relative to the other parts. Hereinafter, the part is described as a “protruding portion 23a”. The position of the connecting member 20 to a sleeve 30 is determined by the protruding portion 23a (later described). The thickness of the protruding portion 23a, that is, the length in the direction corresponding to the thickness direction of the connecting unit 21, is about the same thickness as the flange 23. Further, as shown in FIG. 3B, the continuous plane between the flange 23 and the connecting unit 21 is formed in a tapered form.

The core abutting portion 22 is formed to guide light from one of the multi-core optical fibers to the other. From that point of view, the core abutting portion 22 is formed thinly. Further, in order to thinly form the core abutting portion 22, it is required to ensure the strength of the portion as the connecting member 20. For that reason, the flange 23 is provided to ensure the strength of the connecting member 20.

The connecting member 20 in the embodiment is not limited to the above described mode as long as having the core abutting portion 22.

### [About the Connection Between the Multi-Core Optical Fibers]

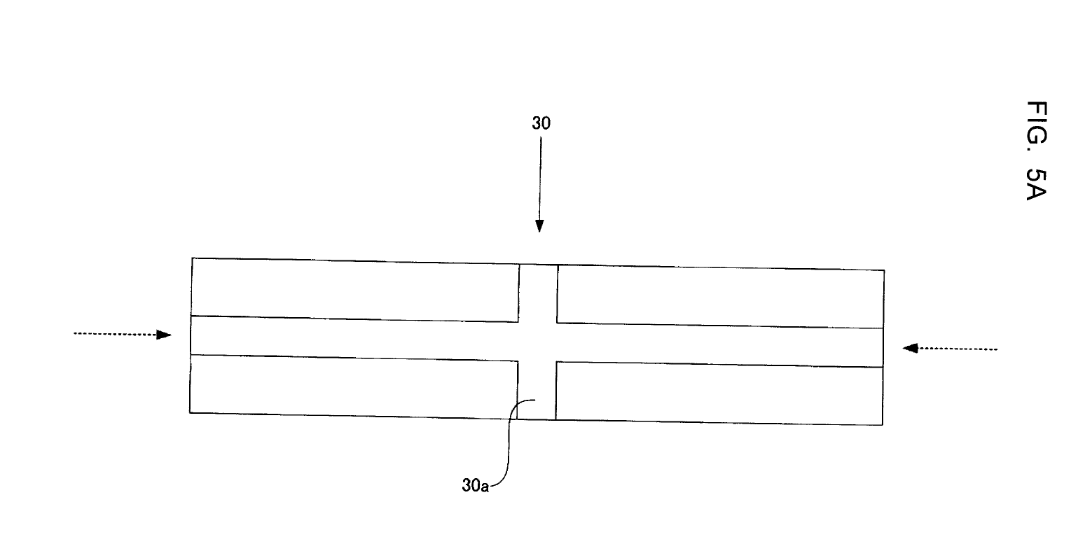

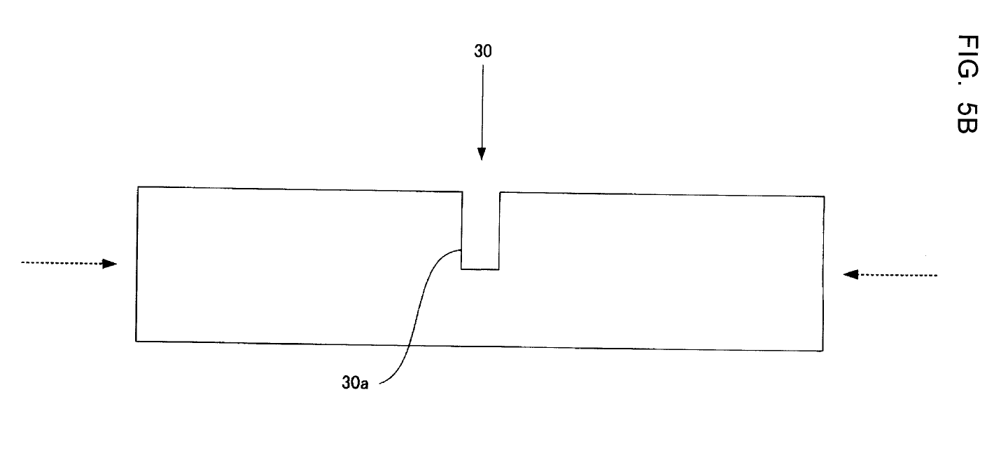

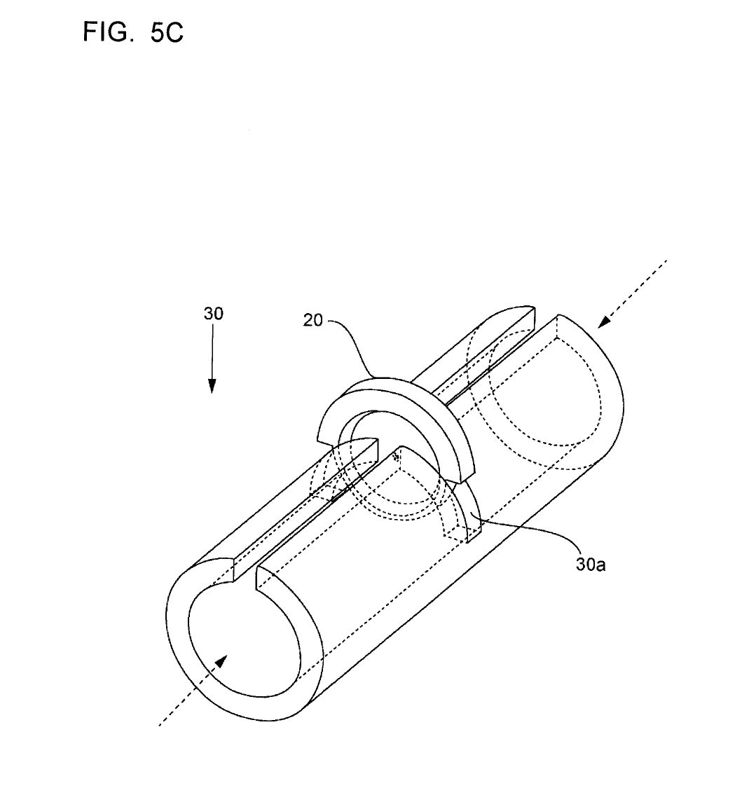

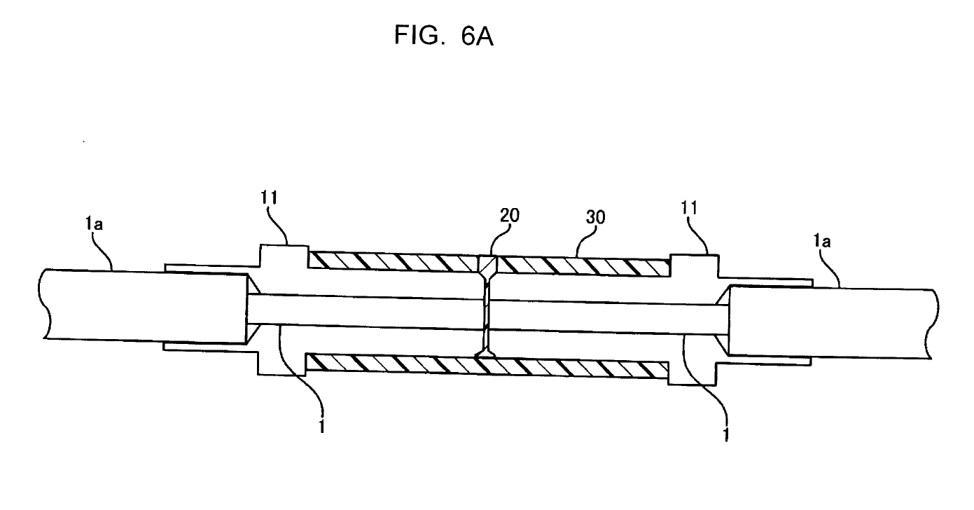

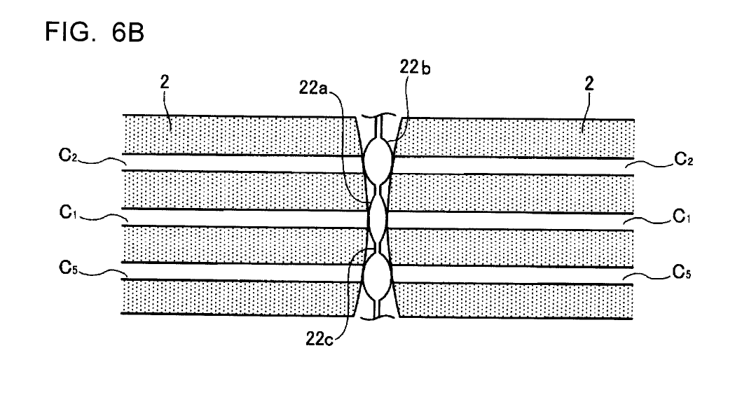

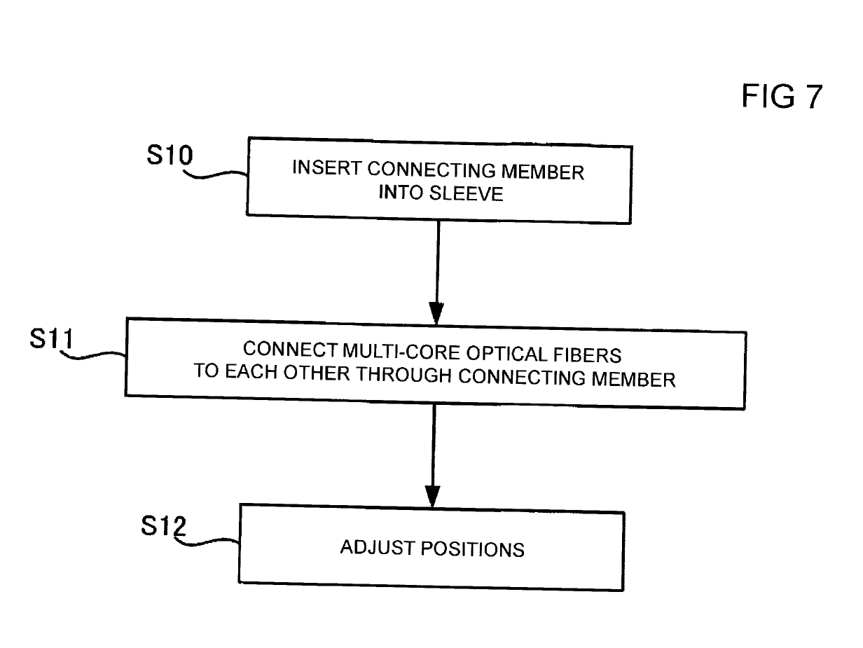

The connection between the multi-core optical fibers through the connecting member 20 is now described with reference to FIG. 5A to FIG. 7. FIG. 5A is a top view of the sleeve 30. FIG. 5B is a side view of the sleeve 30. FIG. 5C is a perspective view of the sleeve 30. FIG. 6A is a cross-sectional view of the multi-core optical fiber 1 and the ferrule 11 in the axial direction. FIG. 6B is a diagram in which the connecting part between the multi-core optical fibers in FIG. 6A is enlarged. In FIG. 6B, the illustration of the ferrule 11 and the sleeve 30 is omitted. FIG. 7A is a flowchart illustrating an example of a connection procedure of the multi-core optical fibers. As described above, the end surface 1b of the multi-core optical fiber 1 (the end surface 11d of the ferrule 11) is subjected to the spherical surface polishing, however, the illustration of the curved surface of the end surface is omitted in some of the figures.

The sleeve 30 is a member in a cylindrical form to which the multi-core optical fibers 1 are inserted. The inner diameter of the sleeve 30 is about the same as the outer diameter of the connecting unit 21 of the connecting member 20. In FIG. 6A, the state that the multi-core optical fibers 1 are inserted in the ferrules 11 is illustrated. In the embodiment, a split sleeve is used as the sleeve 30. The split sleeve is a cylindrical member having a split formed along insertion directions of the multi-core optical fibers 1 (directions illustrated with broken lines in FIG. 5A to FIG. 5C). The insertion directions of the multi-core optical fibers 1 correspond to the axial direction of the split sleeve. Thus, in the outer circumference surface of the split sleeve, a substantially liner split is formed along the axial direction, and the split penetrates from the outer circumference surface to the inner circumference surface of the split sleeve. Further, in the embodiment, an insertion hole 30a is formed so as to be orthogonal to the split of the sleeve 30. That is, the insertion hole 30a is formed so as to be orthogonal to the axial direction of the sleeve 30, that is, the insertion directions of the multi-core optical fibers 1. The connecting member 20 is inserted into the insertion hole 30a so that the radial direction of the sleeve 30 and the radial direction of the connecting member 20 correspond to each other (see FIG. 5C).

The connection configuration of the multi-core optical fibers 1 is configured with the multi-core optical fibers 1, the ferrules 11, and the connecting member 20 as well as such the sleeve 30.

Here, an example of a connection procedure of the multi-core optical fibers is described with reference to FIG. 7.

Firstly, the connecting member 20 is inserted into the insertion hole 30a of the sleeve 30 (S10). At this time, the flange 23 (the protruding portion 23a) and the insertion hole 30a are fitted. The position of the connecting member 20 to the sleeve 30 is determined by the fitting. This step is an example of an “arrangement step”.

The multi-core optical fibers 1 inserted in the respective ferrules 11 are then inserted from the different end parts of the sleeve 30, respectively. The inserted multi-core optical fibers 1 are connected to each other through the connecting member 20 (S11). This step is an example of a “connection step”.

At this time, the core C₁ of one of the multi-core optical fibers 1 is abutted to the first surface of the first resin unit 22a of the connecting member 20 (see FIG. 6B). In the same manner, the core C₁ of the other one of the multi-core optical fibers 1 is abutted to the second surface of the first resin unit 22a. The arrangement of the cores C₁ to C₇ is the same for those two multi-core optical fibers 1. Thus, in the case that the multi-core optical fibers 1 are connected to each other through the connecting member 20 in the sleeve 30; the center cores C₁ are coaxially arranged. Thus, with the use of the connecting member 20, it is possible to suppress the connection loss when light is guided from the core C₁ of one of the multi-core optical fibers 1 to the core C₁ of the other.

The cores C₂ to C₇ of one of the multi-core optical fibers 1 are abutted to the first surface of the second resin unit 22b (see FIG. 6B). In the similar manner, the cores C₂ to C₇ of the other one of the multi-core optical fibers 1 are abutted to the second surface of the second resin unit 22b. In FIG. 6B, only the cores C₂ and C₅ are illustrated. In the case that the connecting member 20 is not used, since the end surfaces 1b of the multi-core optical fibers 1 are subjected to the spherical surface polishing, the spaces S are generated between the cores C₂ to C₇ of one of the multi-core optical fibers 1 and the cores C₂ to C₇ of the other (see FIG. 20). Whereas, in the case that the connecting member 20 is used, since the second resin unit 22b is formed thicker than the first resin unit 22a, the cores C₂ to C₇ of the corresponding multi-core optical fibers 1 are abutted to the first surface and the second surface of the second resin unit 22b. At this time, the core C₁ of one of the multi-core optical fibers 1 is abutted to the first surface of the first resin unit 22a. The core C₁ of the other one of the multi-core optical fibers 1 is abutted to the second surface of the first resin unit 22a.

Here, in the state of S11, the positions of the cores C₂ to C₇ may be shifted in the rotational direction. That is, in the case that the multi-core optical fibers are connected to each other, the axes of the peripheral cores (cores C₂ to C₇) may not coincide with each other even the center cores (cores C₁) coincide with each other.

Thus, after S11 is performed, the position adjustment of the multi-core optical fibers 1 is performed (S12). Specifically, the position adjustment is performed such that the corresponding cores coincide with each other while one of the multi-core optical fibers 1 is rotated with respect to the other. The confirmation of the coincidence of the cores is, for example, performed with a measurement device connected to each core of one of the multi-core optical fibers 1. That is, the measurement device measures light amount of each core. Light is then emitted from each core of the other one of the multi-core optical fibers 1 to measure the light amount of the above each core with the measurement device. Based on the light amount measured with the measurement device, the position with less light loss is confirmed, and the position adjustment is then performed. The step is an example of a “position adjustment step”.

The second resin unit 22b in the embodiment is formed in an annular form. Thus, when the position adjustment in the rotational direction is performed, the position adjustment of the connecting member 20 with the multi-core optical fibers 1 is not required. That is, only the position adjustment of the multi-core optical fibers is required.

In the state that the position adjustment is done, the multi-core optical fibers are fixed with adapters (not shown) or the like. The connection between the multi-core optical fibers is established by this fixing (see FIG. 6A).

As shown in FIG. 6B, the cores C₁ are connected to each other through the first resin unit 22a of the connecting member 20. The cores C₂ to C₇ are also connected to their corresponding cores C₂ to C₇, respectively, through the second resin unit 22b of the connecting member 20. Only some of those cores are illustrated in FIG. 6B. As described above, the connection loss can be reduced by connecting the multi-core optical fibers 1 to each other with the use of the connecting member 20 in the embodiment.

### [Operations and Effects]

Operations and effects of the embodiment are described.

The plurality of cores Cₖ is covered with the clad 2 in the connecting member 20 according to the embodiment. The connecting member 20 is arranged between the end surfaces 1b of the two multi-core optical fibers which have been subjected to the spherical surface polishing. The connecting member 20 includes the first resin unit 22a and the second resin unit 22b. The first cores (cores C₁) of the multi-core optical fibers 1 are in contact with the first resin unit 22a. Further, light from the first core (core C₁) of one of the multi-core optical fibers is guided to the first core (core C₁) of the other through the first resin unit 22a. The second resin unit 22b is formed so as to surround the first resin unit 22a. The second cores (cores C₂ to C₇) of the multi-core optical fibers 1 are in contact with the second resin unit 22b. Also, light from the second core (for example, the core C₂) of one of the multi-core optical fibers is guided to the second core (for example, the core C₂) of the other through the second resin unit 22b. Further, the second resin unit 22b is formed thicker than the first resin unit 22a.

Specifically, the second resin unit 22b is provided in an annular form in the outer side of the first resin unit 22a.

In this way, in the connecting member 20, the thickness of the first resin unit 22a and that of the second resin unit 22b are different from each other according to the shapes of the end surfaces of the multi-core optical fibers 1. The multi-core optical fibers subjected to the spherical surface polishing can therefore be connected to each other without fail. Further, the position adjustment of the multi-core optical fibers 1 with the connecting member 20 in the rotational direction is not required by configuring the second resin unit 22b into an annular form. That is, with the use of the connecting member 20 in the embodiment, it is possible to establish the connection easily, and reduce light connection loss at the time of the multi-core optical fiber connection.

Further, the connection configuration of the embodiment includes the multi-core optical fibers 1, the ferrule 11, the sleeve 30, and the connecting member 20. The plurality of cores Cₖ is covered with the clad 2 in the multi-core optical fiber 1. The ferrule 11 is inserted with the multi-core optical fiber 1. The sleeve 30 is inserted with the ferrule 11. The insertion hole 30a is formed in the sleeve 30. The insertion hole 30a is formed in the direction orthogonal to the insertion directions of the multi-core optical fibers 1. The insertion hole 30a is inserted with the connecting member 20.

Specifically, the outer circumference part of the connecting member 20 is formed with the flange 23 having a predetermined thickness. The insertion hole 30a is fitted with the flange 23. The position of the connecting member 20 to the sleeve 30 is determined by the fitting.

According to the connection configuration described above, it is possible to connect the two multi-core optical fibers which have been subjected to the spherical surface polishing to each other without fail due to the difference in the thickness between the first resin unit 22a and the second resin unit 22b of the connecting member 20. The embodiment can therefore make the configuration simple, and light connection loss at the time of the multi-core optical fiber connection can be reduced.

The connection method of the multi-core optical fibers in the embodiment includes the arrangement step, the connection step, and the position adjustment step. In the arrangement step, in the sleeve 30, the connecting member 20 is arranged in the insertion hole 30a formed in the direction orthogonal to the insertion directions of the multi-core optical fibers 1. In the connection step, the multi-core optical fibers 1 inserted in the respective ferrules 11 are inserted from the both ends of the sleeve 30, respectively. In the connection step, the multi-core optical fibers 1 are connected to each other through the connecting member 20. In the position adjustment step, the positions of the multi-core optical fibers are adjusted.

In the above described connection method, the spaces generated by the shapes of the end surfaces of the two multi-core optical fibers are filled in with the difference between the thickness of the first resin unit 22a of the connecting member 20 and the thickness of the second resin unit 22b thereof. According to such the connection method, it is possible to connect the cores of the two multi-core optical fibers which have been subjected to the spherical surface polishing to each other without fail. Further, it is not required to perform the position adjustment of the multi-core optical fibers with the connection member 20 in the rotational direction by configuring the second resin unit 22b in an annular form. It is therefore required to perform only the position adjustment of the multi-core optical fibers in the rotational direction in the position adjustment step. That is, according to the connection method of the multi-core optical fibers in the embodiment, the connection method is simple, and it is possible to reduce light connection loss at the time of the multi-core optical fiber connection.

### Modified Example of the First Embodiment

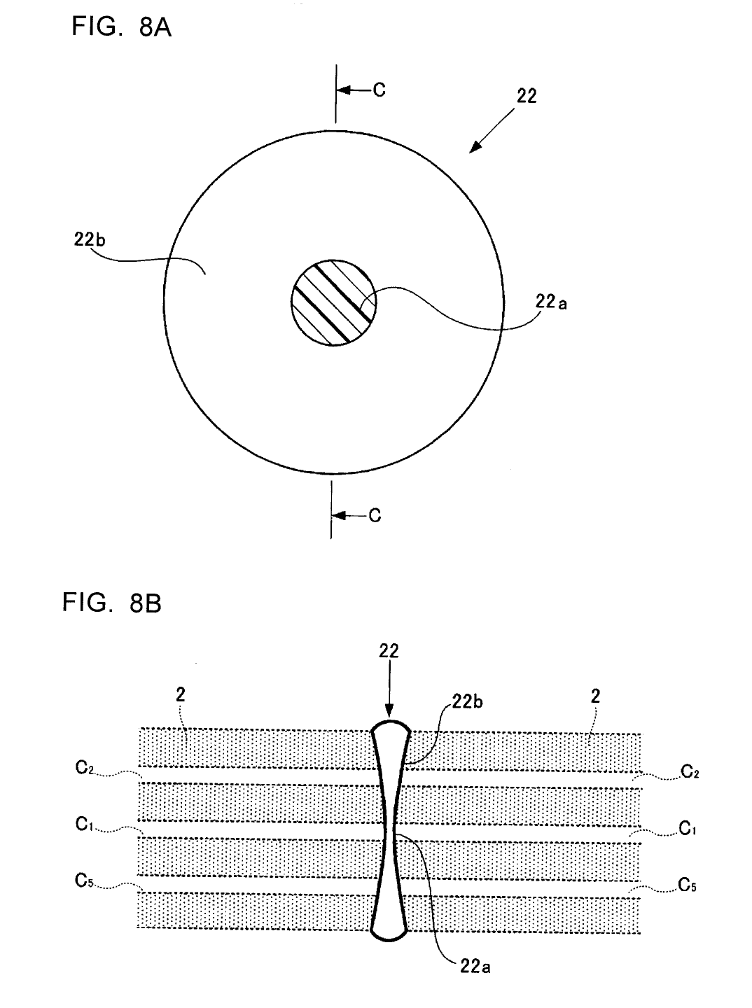

The shape of the connecting member 20 is not limited to the example of the above embodiment. FIG. 8A is a front view of the core abutting portion 22 according to a present modified example. FIG. 8B is a cross-sectional view taken along line C-C of FIG. 8A. In FIG. 8A and FIG. 8B, the illustration of the connecting unit 21 and the flange 23 is omitted. Broken lines in FIG. 8B illustrate the multi-core optical fiber 1 abutted to the core abutting portion 22.

As shown in FIG. 8A and FIG. 8B, the core abutting portion 22 in the modified example has the first resin unit 22a and the second resin unit 22b. The first resin unit 22a is recessed in a spherical surface form unlike in the above embodiment. The second resin unit 22b is arranged continuously with the first resin unit 22a. The second resin unit 22b is provided in an annular form so as to surround the first resin unit 22a.

In the connecting member 20 of the modified example, it is also possible to easily connect the multi-core optical fibers 1 which have been subjected to the spherical surface polishing to each other without fail. That is, in the case that the multi-core optical fibers 1 which have been subjected to the spherical surface polishing are abutted to the core abutting portion 22, the cores C₁ are abutted to the first resin unit 22a, and the cores C₂ to C₇ are abutted to the second resin unit 22b (see FIG. 8B). In the modified example, the connection is more secure as the curvature of the curved surface from the first resin unit 22a to the second resin unit 22b becomes closer to the curvature of the end surface 1b of the multi-core optical fiber 1 which have been subjected to the spherical surface polishing.

That is, as the connecting member 20, the first resin unit 22a is not necessarily protruded independently of the second resin unit 22b. In other word, in the connecting member 20, it suffices if the second resin unit 22b is thicker than the first resin unit 22a.

### Second Embodiment

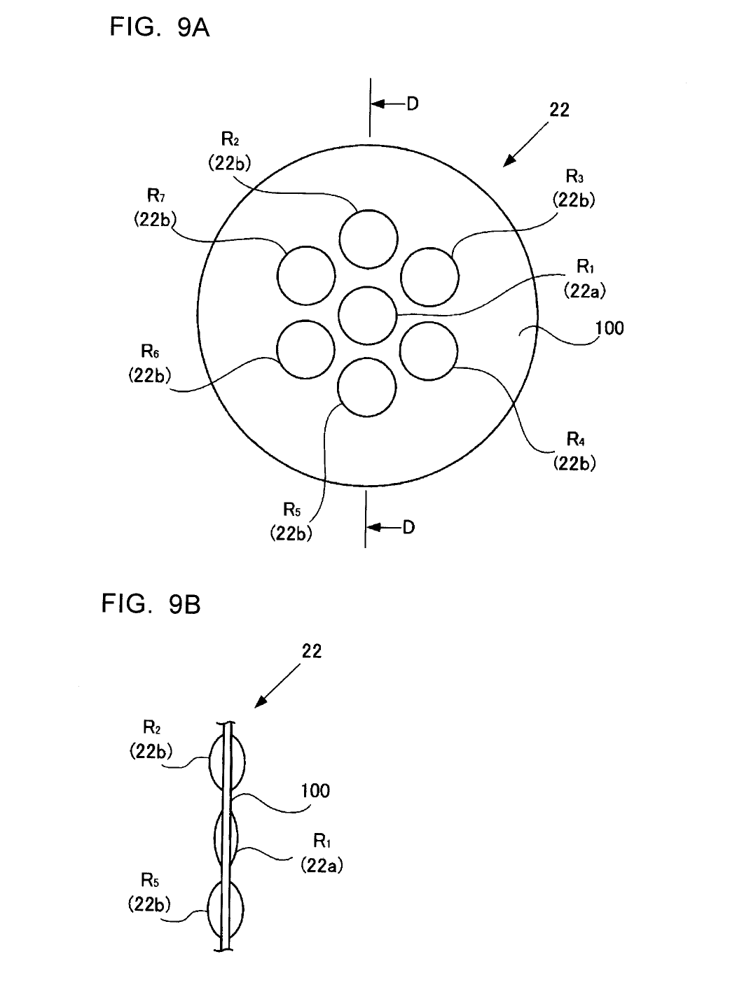

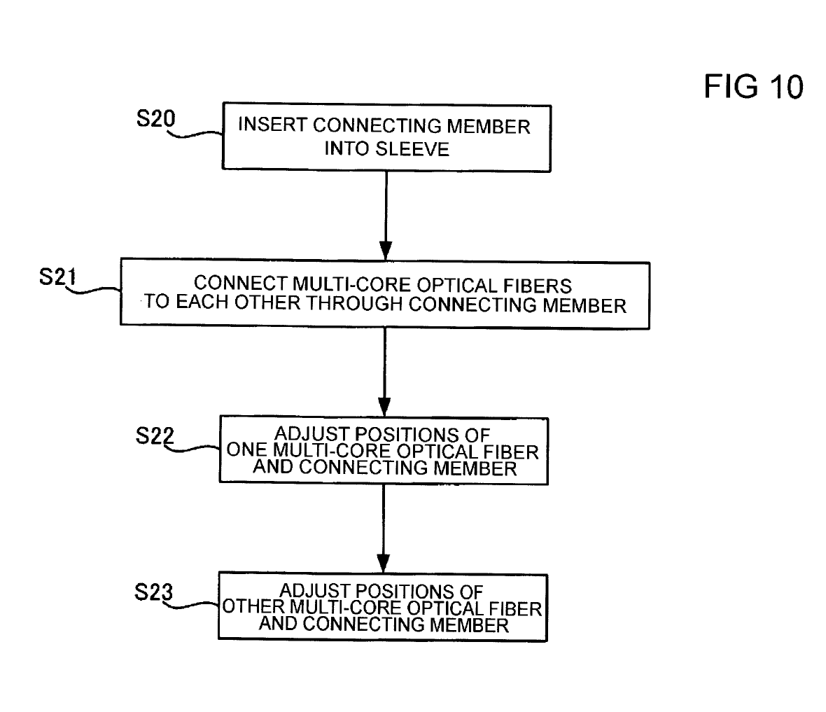

Next, the connecting member 20 in a second embodiment and a connection method of the multi-core optical fibers with the use of the connecting member 20 are described with reference to FIG. 9A to FIG. 10. In the present embodiment, an example in which the first resin unit 22a and the second resin unit 22b of the connecting member 20 are configured as lenses is described. The first resin unit 22a and the second resin unit 22b may be described as a “first lens unit” and a “second lens unit”, respectively, for convenience of explanation. Further, the end surfaces 1b of the multi-core optical fibers 1 in the embodiment are subjected to the spherical surface polishing. Hereinafter, the detailed description of the configuration which is the same as that of the first embodiment is omitted.

### [About the Connecting Member]

The configuration of the core abutting portion 22 in the embodiment is described with reference to FIG. 9A and FIG. 9B. FIG. 9A is a front view of the core abutting portion 22. FIG. 9B is a cross-sectional view taken along line D-D in FIG. 9A.

The core abutting portion 22 in the embodiment has the first resin unit 22a and a plurality of the second resin units 22b.

The first resin unit 22a corresponds to one lens unit R₁. The second resin units 22b correspond to a plurality of lens units Rₖ (k=2 to n). Hereinafter, as the plurality of lens units Rₖ, lens units R₁ to R₇ illustrated in the example in FIG. 9A are described. The lens units R₁ to R₇ are arranged corresponding to the arrangement of the cores in the multi-core optical fiber 1 to be connected. In the embodiment, the lens units R₂ to R₇ are arranged in a scattered manner on a concentric circle with the lens unit R₁ as the center. That is, this arrangement corresponds to the arrangement of the cores C₁ to C₇ of the multi-core optical fiber 1. That is, the lens units in the embodiment are arranged in an array on a surface in contact with the multi-core optical fiber 1 (see FIG. 9A).

For example, each lens unit is arranged on a wafer 100 having the same size as the outer diameter of the ferrule 11. Each lens unit is arranged on the center part, for example, of the wafer 100. Each lens unit corresponds to the core abutting portion 22. A region other than the core abutting portion 22 corresponds to the connecting unit 21. As described above, as the method for arranging the plurality of lens units on the wafer 100, it is possible to apply a known wafer lens manufacturing method. Also, the flange 23 is arranged at the outer circumference of the connecting unit 21, as in the first embodiment.

The lens unit R₁ is in contact with the core C₁ of the multi-core optical fiber 1. The lens units R₂ to R₇ are in contact with the cores C₂ to C₇ of the corresponding multi-core optical fiber 1, respectively. The lens R₁ in the embodiment is an example of a “first lens unit”. The lens units R₂ to R₇ in the embodiment are an example of a “plurality of second lens units”.

The lens unit R₁ (the first resin unit 22a) in the embodiment protrudes in a convex curved surface form (for example, a spherical surface form). That is, the lens unit R₁ is formed so as to be gradually thicker toward the protruding end from the surface of the wafer 100. Further, the lens unit R₁ is provided on both sides of the connecting member 20 (see FIG. 9B).

The lens units R₂ to R₇ (the second resin units 22b) are each formed protruding in a convex curved surface form (for example, a spherical surface form). That is, the lens units R₂ to R₇ are formed so as to be gradually thicker toward the protruding end from the surface of the wafer 100. Further, the lens units R₂ to R₇ are provided on both sides of the connecting member 20 (see FIG. 9B. Only the lens units R₂ and R₅ are illustrated in FIG. 9B).

Here, the lens units R₂ to R₇ are formed thicker than the lens unit R₁ (see FIG. 9B). That is, the second resin units 22b are formed thicker than the first resin unit 22a, similarly to the first embodiment.

### [About the Connection Between the Multi-Core Optical Fibers]

Next, the connection between the multi-core optical fibers through the connecting member 20 is described in detail with reference to FIG. 10. FIG. 10 is a flowchart illustrating an example of a connection procedure of the multi-core optical fibers. Hereinafter, the connection procedure of the multi-core optical fibers 1 in which the end surfaces 1b have been subjected to the spherical surface polishing (the ferrules 11 in which the end surfaces 11d have been subjected to the spherical surface polishing) is described.

Firstly, the insertion hole 30a of the sleeve 30 is inserted with the connecting member 20 (S20). At this time, the flange 23 (the protruding portion 23a) of the connecting member 20 is fitted with the insertion hole 30a of the sleeve 30. The position of the connecting member 20 to the sleeve 30 is determined by the fitting. This step is an example of the “arrangement step”.

The multi-core optical fibers 1 inserted in the respective ferrules 11 are inserted from the different end parts of the sleeve 30, respectively. Further, the inserted multi-core optical fibers 1 are connected to each other through the connecting member 20 (S21). This step is an example of the “connection step”

At this time, the core C₁ of the one of the multi-core optical fibers 1 is abutted to the lens unit R₁ on one surface of the connecting member 20. Similarly, the core C₁ of the other one of the multi-core optical fibers 1 is abutted to the lens unit R₁ on the other surface thereof. In those two multi-core optical fibers 1, the arrangement of the cores C₁ to C₇ is the same. Therefore, in the case that the multi-core optical fibers 1 are connected to each other through the connecting member 20 in the sleeve 30, the cores C₁ in the center are coaxially arranged. Therefore, with the use of the connecting member of the second embodiment, it is possible to suppress connection loss when light is guided from the core C₁ of one of the multi-core optical fibers 1 to the core C₁ of the other.

Here, in the state of S21, the positions of the cores C₂ to C₇ may be shifted in the rotational direction. That is, when the multi-core optical fibers are connected to each other, the axes of the peripheral cores (cores C₂ to C₇) may not coincide with each other even the axes of the center cores (cores C₁) are coincide.

In the embodiment, after S21 is performed, the position adjustment of one of the multi-core optical fibers 1 with the connecting member 20 is performed (S22). Specifically, the each position of the cores (cores C₂ to C₇) is adjusted so as to fit with the corresponding lens unit (lens units R₂ to R₇) while the one of the multi-core optical fibers is rotated with respect to the connecting member 20. This step is an example of a “first position adjustment step”.

The position adjustment of the other one of the multi-core optical fibers 1 with the connecting member 20 is then performed (S23). Specifically, each position of the cores (cores C₂ to C₇) is adjusted so as to fit with the corresponding lens unit (lens units R₂ to R₇) while the other one of the multi-core optical fibers 1 is rotated with respect to the connecting member 20. This step is an example of a “second position adjustment step”.

By performing S22 and S23, the cores C₂ to C₇ of the two multi-core optical fibers 1 are abutted to the lens units R₂ to R₇ (the second resin units 22b), respectively. In the case of using the multi-core optical fibers 1 in which the end surfaces 1b have been subjected to the spherical surface polishing, spaces are generated between the cores C₂ to C₇ without the existence of the connecting member 20 (see FIG. 20). Those spaces can, however, be filled by using the connecting member 20. That is, since the lens units R₂ to R₇ (the second resin units 22b) are formed to be thicker than the lens unit R₁ (the first resin unit 22a), each of the lens units R₂ abuts on R₇ the corresponding one of the cores C₂ to C₇ of the multi-core optical fibers 1 on one and the other surface of the wafer 100, and thus the spaces can be filled.

After that, in the state that the position adjustment is done, each of the multi-core optical fibers is fixed by the adapter (not shown) or the like. The connection between the multi-core optical fibers is established by this fixing.

### [Operations and Effects]

Operations and effects of the embodiment are described.

The first resin unit 22a in the connecting member 20 according to the embodiment includes one first lens unit (lens unit R₁). Also, the second resin units 22b of the connecting member 20 include the plurality of second lens units (lens units R₂ to R₇). The first lens unit is in contact with the first cores (cores C₁) of the multi-core optical fibers 1. The second lens units are respectively in contact with the corresponding second cores (cores C₂ to C₇) of the corresponding multi-core optical fibers 1.

Specifically, the plurality of the second lens units is coaxially arranged on a concentric circle with the first lens unit as the center.

In this way, according to the shapes of the end surfaces of the multi-core optical fibers 1, the connecting member 20 is provided with the first lens unit (the first resin unit 22a) and the plurality of the second lens units (the second resin units 22b) having different thickness. Thus, it becomes possible to connect the cores of the multi-core optical fibers which have been subjected to the spherical surface polishing to each other without fail. That is, with the use of the connecting member 20 in the embodiment, it is possible to easily establish the connection, and reduce the light connection loss at the time of the multi-core optical fiber connection.

Further, the connection method of the multi-core optical fibers in the embodiment includes the arrangement step, the connection step, the first position adjustment step, and the second position adjustment step. In the arrangement step, in the sleeve 30, the connecting member 20 is arranged in the insertion hole 30a formed in the direction orthogonal to the insertion directions of the multi-core optical fibers 1. In the connection step, the multi-core optical fibers 1 inserted in the respective ferrules 11 are inserted from the both ends of the sleeve 30, respectively. In the connection step, the multi-core optical fibers 1 are connected to each other through the connecting member 20. In the first position adjustment step, the positions of one of the multi-core optical fibers with the connecting member 20 are adjusted. In the second position adjustment step, the positions of the other one of the multi-core optical fibers with the connecting member 20 are adjusted.

With the above described connection method, the spaces generated by the shapes of the end surfaces of the multi-core optical fibers are filled due to the difference in the thickness between the first lens unit (the first resin unit 22a) and the second lens units (the second resin units 22b) of the connecting member 20. According to such the connection method, it is possible to connect the multi-core optical fibers which have been subjected to the spherical surface polishing to each other without fail. That is, according to the connection method of the multi-core optical fibers in the embodiment, the connection method is simple, and the light connection loss at the time of the multi-core optical fiber connection can be reduced.

### Third Embodiment

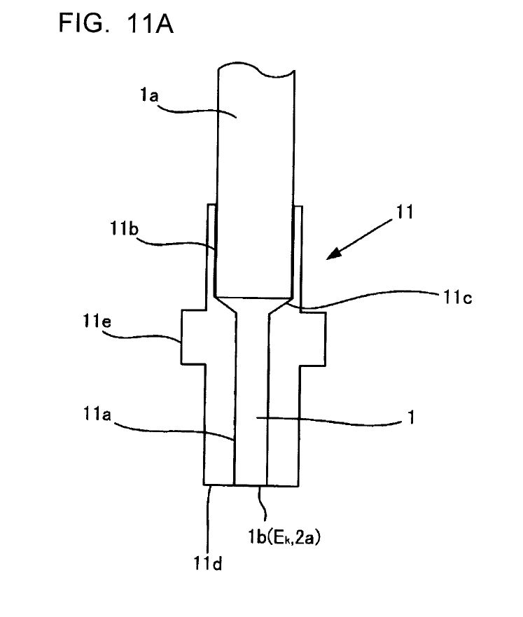

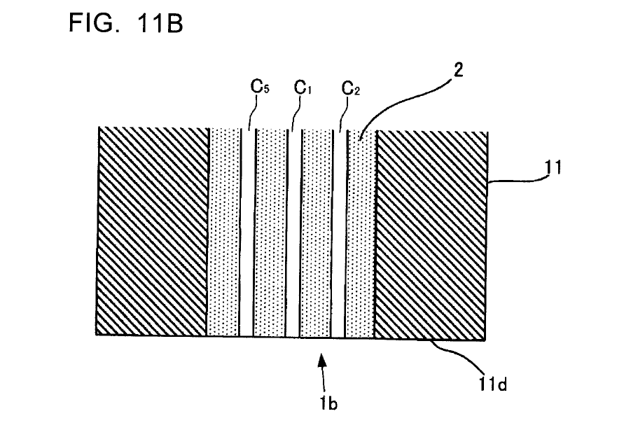

Next, the connecting member 20 and a connection method of the multi-core optical fibers with the use of the connecting member 20 in a third embodiment are described with reference to FIG. 11A to FIG. 13. The connecting member 20 described in the present embodiment is used when both of the end surfaces 1b of the two multi-core optical fibers 1 to be connected are plane. Hereinafter, the detailed description of the configuration which is the same as that of the first embodiment and the second embodiment is omitted.

### [About the End Surface Shape of the Multi-Core Optical Fiber]

The end surface shape of the multi-core optical fiber 1 in the embodiment is described with reference to FIG. 11A and FIG. 11B. FIG. 11A is a cross-sectional view of the multi-core optical fiber 1 and the ferrule 11 in the axial direction. FIG. 11B is an enlarged diagram illustrating the tip end part of the multi-core optical fiber 1 and the ferrule 11 in the FIG. 11A.

In the same manner as in the first embodiment, the multi-core optical fiber 1 is covered with the protective material 1a, such as plastic or the like. Further, the space 11a in a cylindrical form and the space 11b connecting to the space 11a through the tapered surface 11c are provided in the ferrule 11. The space 11b is also in a cylindrical form, and the diameter thereof is larger than that of the space 11a. The multi-core optical fiber 1 is inserted into the space 11a. The space 11b is inserted with the protective material 1a.

In the embodiment, the end surface 1b of the multi-core optical fiber 1 and the end surface 11d of the ferrule 11 are subjected to plane surface polishing for forming those surfaces in a plane form as a whole (see FIG. 11A). By performing the plane surface polishing, the end surface 1b (the end surfaces Eₖ of the cores Cₖ and the end surface 2a of the clad 2) and the end surface 11d of the ferrule 11 form the same plane (see FIG. 11B). The multi-core optical fiber 1 is an example of a “first multi-core optical fiber” or a “second multi-core optical fiber”.

### [About the Connecting Member]

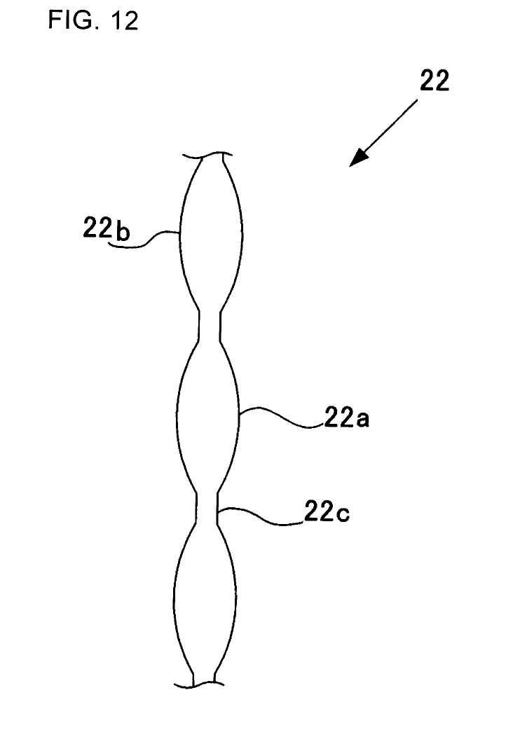

The configuration of the core abutting portion 22 in the embodiment is described with reference to FIG. 12. FIG. 12 is a cross-sectional view of the core abutting portion 22 in the embodiment.

The core abutting portion 22 has the first resin unit 22a, the second resin unit 22b, and the groove 22c, similarly to the first embodiment. The second resin unit 22b is provided in an annular form so as to surround the first resin unit 22a (see FIG. 4A of the first embodiment).

In the embodiment, the first resin unit 22a and the second resin unit 22b are formed to have the same thickness (see FIG. 12).

In the same manner as in the first embodiment, the core abutting portion 22 is provided in a part of the connecting unit 21, and the flange 23 is formed so as to surround the outer circumference of the connecting unit 21.

### [About the Connection Between the Multi-Core Optical Fibers]

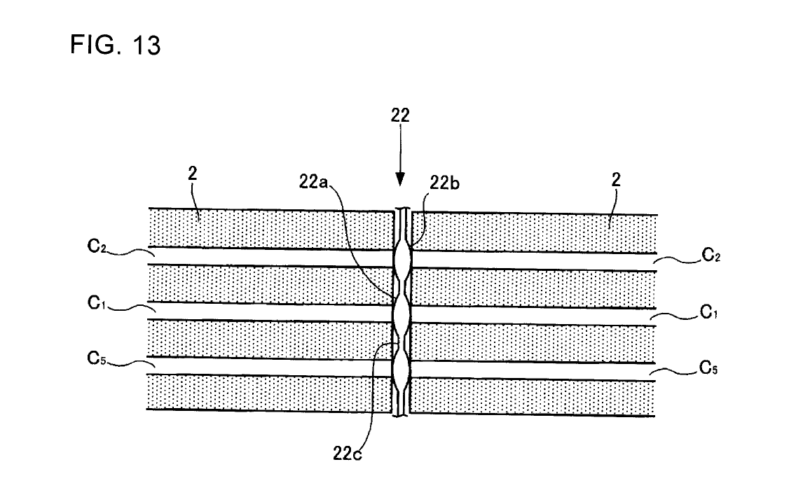

Next, the connection between the multi-core optical fibers through the connecting member 20 is described in detail with reference to FIG. 13. FIG. 13 is an enlarged diagram of the connecting part of the multi-core optical fibers in the embodiment. In FIG. 13, the description of the ferrule 11 and the sleeve 30 is omitted. As described above, the end surface 1b of the multi-core optical fiber 1 is subjected to the plane surface polishing.

In the connection between the multi-core optical fibers in the embodiment, the connecting member 20 is firstly inserted into the insertion hole 30a of the sleeve 30, similarly to the first embodiment (S10).

The multi-core optical fibers 1 inserted in the respective ferrules 11 are then inserted from the both ends of the sleeve 30, respectively. The inserted multi-core optical fibers are connected to each other through the connecting member 20 (S11).

At this time, the core C₁ of one of the multi-core optical fibers 1 is abutted to the first surface of the first resin unit 22a of the connecting member 20 (see FIG. 13). Similarly, the core C₁ of the other one of the multi-core optical fibers 1 is abutted to the second surface of the first resin unit 22a. In the two multi-core optical fibers 1, the arrangement of the cores C₁ to C₇ is the same. Thus, when the multi-core optical fibers 1 are connected to each other through the connecting member 20 in the sleeve 30, the center cores C1 are coaxially arranged. Therefore, with the use of the connecting member 20, it is possible to suppress connection loss when light is guided from the core C₁ of one of the multi-core optical fibers 1 to the core C₁ of the other.

Each of the cores C₂ to C₇ of one of the multi-core optical fibers 1 is abutted to the second resin unit 22b formed to have the same thickness as that of the first resin unit 22a (See FIG. 13).

Here, in the state of S11, the positions of the cores C₂ to C₇ may be shifted in the rotational direction. That is, in the case that the multi-core optical fibers are connected to each other, the axes of the peripheral cores (cores C₂ to C₇) may not coincide with each other even the center cores (cores C₁) coincide with each other.

Thus, after S11 is performed, the position adjustment of the multi-core optical fibers 1 is performed (S12).

Here, the second resin unit 22b in the embodiment is formed in an annular form, similarly to the first embodiment. Therefore, in the rotational direction, the position adjustment of the connecting member 20 with the multi-core optical fibers 1 is not required. That is, only the position adjustment of the multi-core optical fibers is required to be performed.

After that, in the state that the position adjustment is done, the multi-core optical fibers are fixed by the adapters (not shown) or the like. The connection between the multi-core optical fibers is established by this fixing.

### [Operations and Effects]

Operations and effects of the embodiment are described.

In the connecting member 20 according to the embodiment, the plurality of cores Cₖ is covered with the clad 2. Also, the connecting member 20 is arranged between the end surfaces 1b of the two multi-core optical fibers 1 which have been subjected to the plane surface polishing. The connecting member 20 has the first resin unit 22a and the second resin unit 22b. The first resin unit 22a is in contact with the first cores (cores C₁) of the multi-core optical fibers 1. Further, light from the first core (core C₁) of one of the multi-core optical fibers 1 is guided to the first core (core C₁) of the other via the first resin unit 22a. The second resin unit 22b is provided in an annular form so as to surround the first resin unit 22a. The second resin unit 22b is in contact with the second cores (cores C₂ to C₇) of the multi-core optical fibers 1. Also, light from the second core (for example, the core C₂) of one of the multi-core optical fibers 1 is guided to the second core (for example, the core C₂) of the other via the second resin unit 22b. The second resin unit 22b is also formed to have the same thickness as that of the first resin unit 22a.

In this way, in the third embodiment, according to the shapes of the end surfaces of the multi-core optical fibers 1, the connecting member 20 is provided with the first resin unit 22a and the second resin unit 22b having the same thickness. Thus, it becomes possible to connect the two multi-core optical fibers which have been subjected to the plane surface polishing to each other without fail. Further, the position adjustment of the multi-core optical fibers 1 with the connecting member 20 in the rotational direction is not required by configuring the second resin unit 22b in an annular form. That is, with the use of the connecting member 20 in the embodiment, it is possible to easily establish the connection, and reduce the light connection loss at the time of the multi-core optical fiber connection.

### Modified Example 1

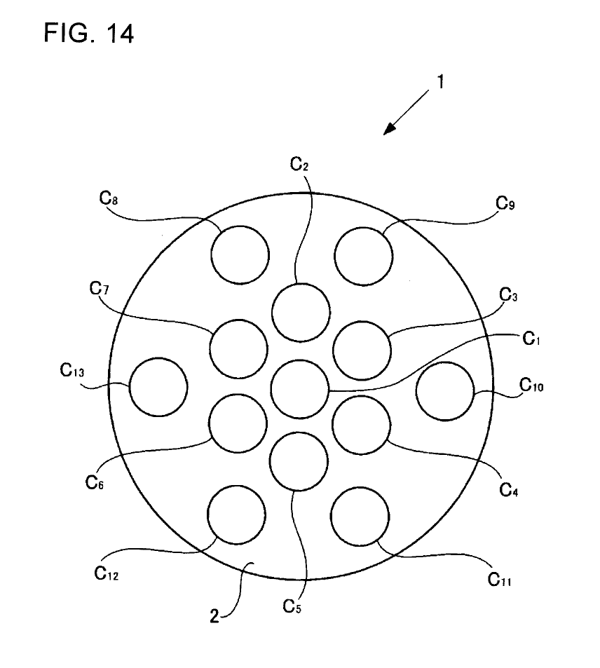

The multi-core optical fibers 1 having seven cores have been described above. The number of the cores is, however, not limited to this. For example, as shown in FIG. 14, the configuration of the connecting member 20 can be applied even in the case that the multi-core optical fibers 1 having thirteen cores (cores C₁ to C₁₃) are connected. In the example shown in FIG. 14, the cores C₂ to C₇ (the second cores) are arranged on a concentric circle with the core C₁ (the first core) as the center. Further, cores C₈ to C₁₃ are arranged on the concentric circle to surround the cores C₂ to C₇. The cores C₈ to C₁₃ are examples of “third cores”. Core pitches of the arrangement of the second cores and the arrangement of the third cores are different.

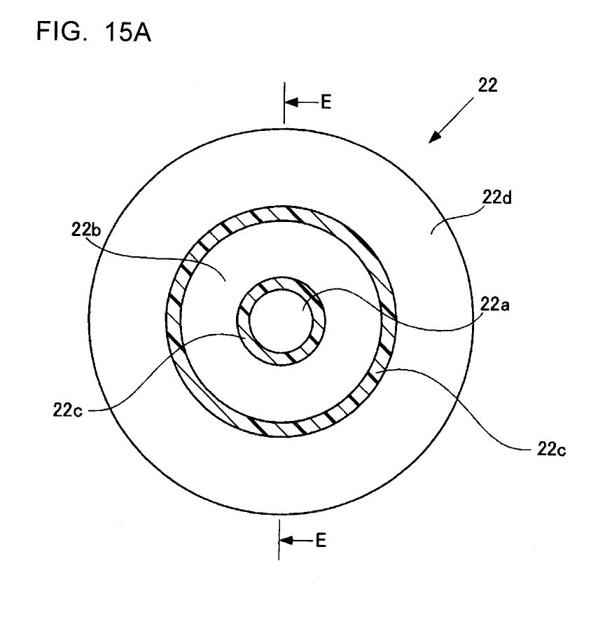

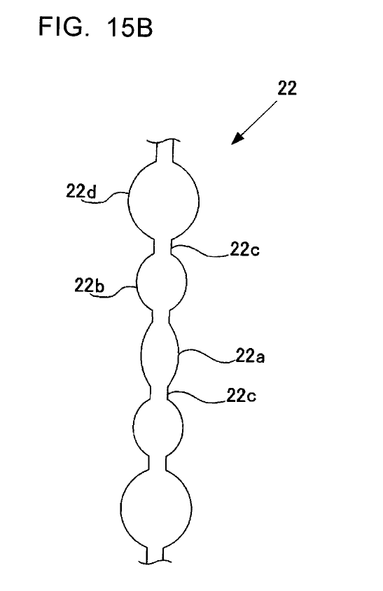

The connecting member 20 (the core abutting portion 22) described here is used for the multi-core optical fiber 1 having the spherically polished end surface 1b. As shown in FIG. 15A and FIG. 15B, the core abutting portion 22 includes the first resin unit 22a, the second resin unit 22b, and a third resin unit 22d. The third resin unit 22d is formed outside of the first resin unit 22a and the second resin unit 22b (FIG. 15B is a cross-sectional view taken along line E-E of FIG. 15A). The third resin unit 22d is provided in an annular form so as to surround the second resin unit 22b. The third resin unit 22d is in contact with the third cores of the multi-core optical fibers 1. Light from the third core (for example, the core C₃) of one of the multi-core optical fibers 1 is guided to the third core (for example, the core C₃) of the other. The third resin unit 22d is formed thicker than the second resin unit 22b. Further, the grooves 22c are formed between the resin units.

In the case that the embodiment is applied to the configuration of the second embodiment, it is possible to configure not only the second resin unit 22b but also the third resin unit 22d with a plurality of lens units (third lens units).

Further, in the case that the end surface 1b of the multi-core optical fiber 1 is subjected to the plane surface polishing; the first to third resin units 22a to 22d are formed to have the same thickness. In this configuration, light from the cores of one of the multi-core optical fibers can be guided to the cores of the other by simply adjusting the positions of the multi-core optical fibers. That is, the position adjustment of the connecting member 20 with the multi-core optical fibers 1 becomes unnecessary.

In this way, even in the case that the number of cores is increased, the connection between the multi-core optical fibers is possible while the connection loss is reduced, by forming a plurality of resin units in the connecting member 20 (the core abutting portion 22). Further, in the case that the end surfaces 1b of the multi-core optical fibers 1 are subjected to the spherical surface polishing, the connection loss can be reduced and the multi-core optical fibers can be connected to each other by forming the outside resin units thicker than the inside resin units.

### Modified Example 2

The example in which the core C₁ is arranged in the center of the multi-core optical fiber 1 has been described in the above embodiments. The configuration of the connecting member 20 in the above embodiment can, however, be applied even to the configuration without having the core in the center.

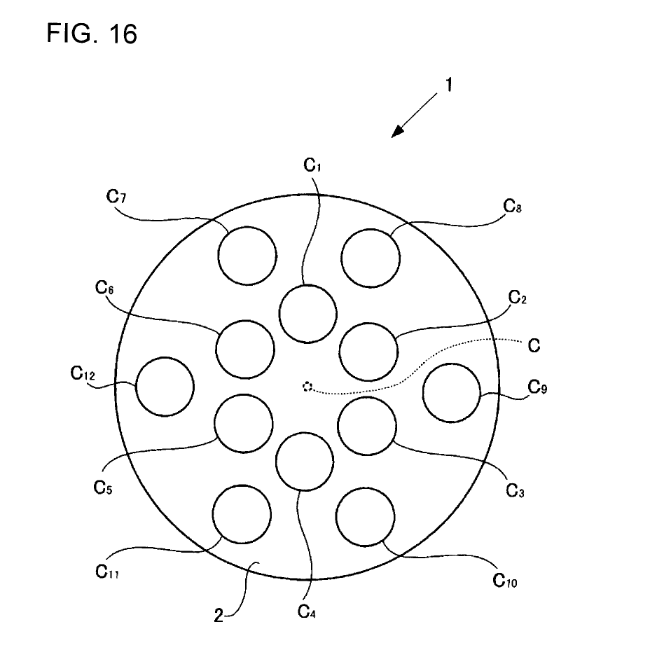

For example, the multi-core optical fiber 1 shown in FIG. 16 is described as an example. This multi-core optical fiber 1 is not provided with a core in a center C of the multi-core optical fiber 1. Further, in this multi-core optical fiber 1, the cores C₁ to C₆ are arranged on a concentric circle with the center C as the center and the cores C₇ to C₁₂ are arranged so as to surround the cores C₁ to C₆.

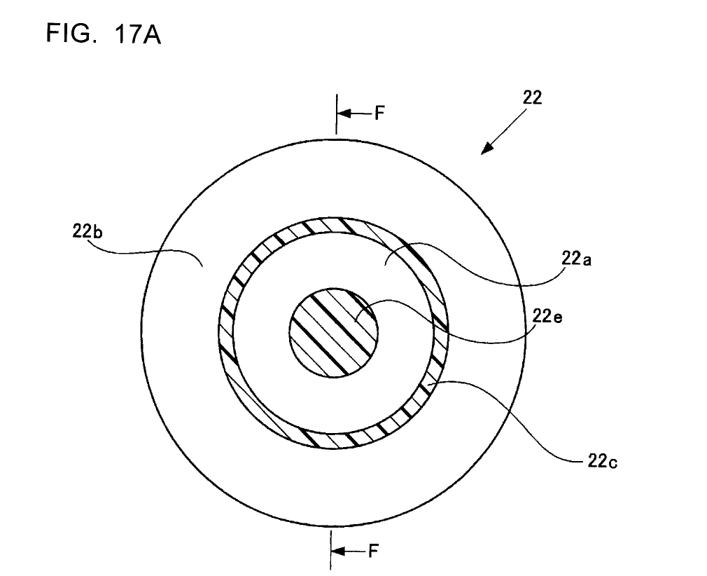

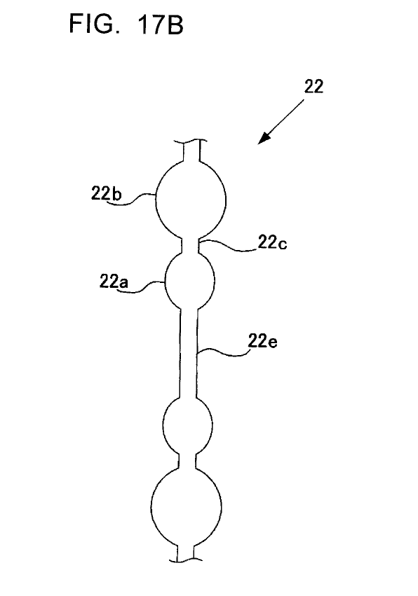

The connecting member 20 (the core abutting portion 22) described here is used for the multi-core optical fiber 1 having the spherically polished end surface 1b. As shown in FIG. 17A and FIG. 17B, the first resin unit 22a is provided in an annular form with the center C (not shown) of the multi-core optical fiber 1 as the center. Also, the second resin unit 22b is provided in an annular form outside of the annular first resin unit 22a. FIG. 17B is a cross-sectional view taken along line F-F of FIG. 17A. The second resin unit 22b is formed thicker than the first resin unit 22a. Further, a flatter portion 22e is formed at the center of the core abutting portion 22, and the groove 22c is formed between the resin units.

In the case that the present embodiment is applied to the configuration of the second embodiment, the first resin unit 22a may be configured with a plurality of lens units (the first lens units).

Further, in the case that the end surface 1b of the multi-core optical fiber 1 is subjected to the plane surface polishing; the first resin unit 22a and the second resin unit 22b are formed to have the same thickness. In this case, light from the cores of one of the multi-core optical fibers can be guided to the cores of the other by simply adjusting the positions of the multi-core optical fibers 1. That is, the position adjustment of the connecting member 20 with the multi-core optical fibers 1 becomes unnecessary.

In this way, the connection between the multi-core optical fibers is possible while the connection loss is reduced, by configuring the resin units in the connecting member 20 (the core abutting portion 22) according to the positions of the cores.

### Fourth Embodiment

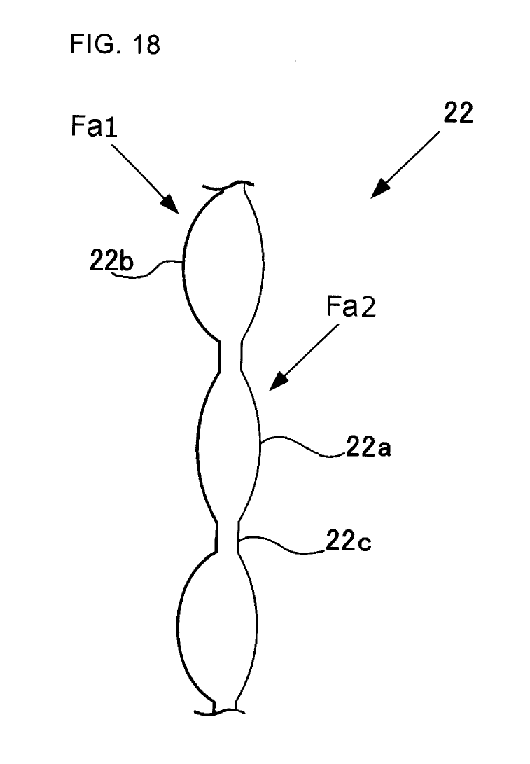

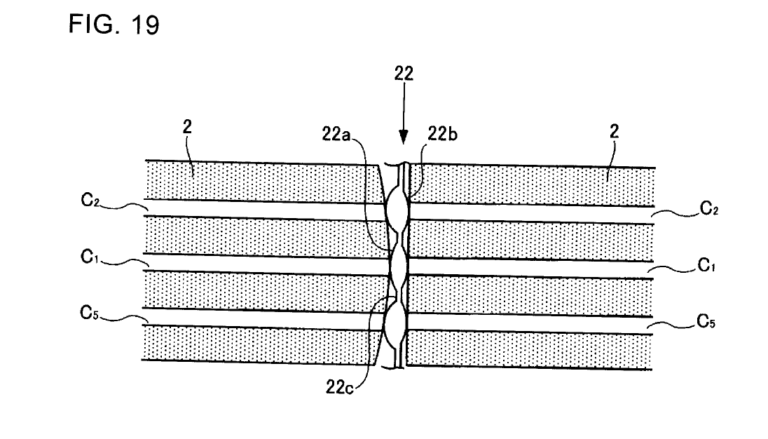

Next, the connecting member 20 and a connection method of the multi-core optical fibers with the use of the connecting member 20 in a fourth embodiment are described with reference to FIG. 2C, FIG. 2D, FIG. 4A, FIG. 18, and FIG. 19. The connecting member 20 to be described in the present embodiment is used in the case such that the end surface 1b of a first multi-core optical fiber to be connected is a convex curved surface (see FIG. 2D) and the end surface 1b of a second multi-core optical fiber to be connected is a plane surface (see FIG. 11B). Hereinafter, the detailed description of the configuration which is the same as that of the first embodiment to the third embodiment is omitted.

### [About the End Surface Shape of the First Multi-Core Optical Fiber]

The end surface shape of the first multi-core optical fiber in the embodiment is described with reference to FIG. 2C and FIG. 2D. The first multi-core optical fiber may have the same configuration as that of the multi-core optical fiber 1 in the first embodiment.

In the embodiment, the end surface 1b of the first multi-core optical fiber and the end surface 11d of the ferrule 11 are subjected to the spherical surface polishing for forming those surfaces in a concave curved surface form (see FIG. 2C) as a whole. By performing the spherical surface polishing, the end surface 1b (the end surfaces Eₖ of the cores Cₖ and the end surface 2a of the clad 2) and the end surface 11d of the ferrule 11 form the same curved surface (see FIG. 2C).

### [About the End Surface Shape of the Second Multi-Core Optical Fiber]

The end surface shape of the multi-core optical fiber in the embodiment is described with reference to FIG. 11A and FIG. 11B. The second multi-core optical fiber may have the same configuration as that of the multi-core optical fiber 1 in the third embodiment.

In the embodiment, the end surface 1b of the multi-core optical fiber 1 and the end surface 11d of the ferrule 11 are subjected to the plane surface polishing for forming those surfaces in a plane surface form as a whole (see FIG. 11A). By performing the plane surface polishing, the end surface 1b (the end surfaces Eₖ of the cores Cₖ and the end surface 2a of the clad 2) and the end surface 11d of the ferrule 11 form the same plane surface (see FIG. 11B).

### [About the Connecting Member]

The configuration of the core abutting portion 22 in the embodiment is described with reference to FIG. 18. FIG. 18 is a cross-sectional view of the core abutting portion 22 in the embodiment.

The core abutting portion 22 has the first resin unit 22a, the second resin unit 22b, and the grooves 22c. As shown in FIG. 18, correspondingly to one of the surfaces of the connecting member 20, a first surface Fa1 of the first resin unit 22a and a first surface Fa1 of the second resin unit 22b are provided. This first surface Fa1 is abutted with the first multi-core optical fiber having the spherically polished end surface. In the first surface Fa1 of the core abutting portion 22, the first resin unit 22a and the second resin unit 22b are formed to have different thicknesses (left side of the FIG. 18). In the example in FIG. 18, the first surface Fa1 of the second resin unit 22b is formed to be more protruded in the thickness direction than the first surface Fa1 of the first resin unit 22a.

Whereas, correspondingly to the other one of the surfaces of the connecting member 20, a second surface Fa2 of the first resin unit 22a and a second surface Fa2 of the second resin unit 22b are provided. This second surface Fa2 is abutted with the second multi-core optical fiber having the plane polished end surface. In the second surface Fa2 of the core abutting portion 22, the first resin unit 22a and the second resin unit 22b are formed to have the same thickness (right side of the FIG. 18). In the example in FIG. 18, the protruding height of the second surface Fa2 of the second resin unit 22b in the thickness direction is the same as that of the second surface Fa2 of the first resin unit 22a.

In an example of the embodiment shown in FIG. 18, the second resin unit 22b is provided in an annular form so as to surround the first resin unit 22a in both of the first surface Fa1 and the second surface Fa2, similarly to the first and the third embodiments (see FIG. 4A). The configuration is, however, not limited to this, and the core abutting portion 22 in the above described embodiments in FIG. 9A, FIG. 14 and FIG. 15 can be applied to the present embodiment.

Like the above embodiments, the core abutting portion 22 is provided in a part of the connecting unit 21, and the flange 23 is formed so as to surround the outer circumference of the connecting unit 21.

### [About the Connection Between the Multi-Core Optical Fibers]

Next, the connection between the multi-core optical fibers through the connecting member 20 is described with reference to FIG. 19. FIG. 19 is an enlarged diagram of the connecting part of the multi-core optical fibers in the embodiment. In FIG. 19, the description of the ferrule 11 and the sleeve 30 is omitted. As described above, it is assumed that the end surface of the first multi-core optical fiber is subjected to the spherical surface polishing, and the end surface of the second multi-core optical fiber is subjected to the plane surface polishing.

In the connection between the multi-core optical fibers in the embodiment, the connecting member 20 is firstly inserted into the insertion hole 30a of the sleeve 30, similarly to the first embodiment (S10).

The first multi-core optical fiber is then inserted from one end of the sleeve 30 so as to face the first surface Fa1 of the core abutting portion 22 of the connecting member 20. The second multi-core optical fiber is inserted from the other end of the sleeve 30 so as to face the second surface Fa2 of the core abutting portion 22. Those inserted multi-core optical fibers are connected to each other through the connecting member 20 (S11).

At this time, the core C₁ of the first multi-core optical fiber is abutted to the first surface Fa1 of the first resin unit 22a of the connecting member 20 (see FIG. 19). Similarly, the core C₁ of the second multi-core optical fiber is abutted to the second surface Fa2 of the first resin unit 22a. In the two multi-core optical fibers 1, the cores C₁ to C₇ are arranged at the same interval. Thus, when the multi-core optical fibers 1 are connected to each other through the connecting member 20 in the sleeve 30, the center cores C₁ are coaxially arranged. Therefore, with the use of the connecting member 20, it is possible to suppress connection loss when light is guided from the core C₁ of one of the multi-core optical fibers 1 to the core C₁ of the other.

Each of the cores C₂ to C₇ of the first multi-core optical fiber is abutted to the second surface Fa2 of the second resin unit 22b which is formed to have a higher protruding height in the thickness direction of the connecting member 20 than that of the first resin unit 22a (see FIG. 19). Each of the cores C₂ to C₇ of the second multi-core optical fiber is abutted to the second surface Fa2 of the second resin unit 22b formed to have the same thickness as that of the first resin unit 22a.

Here, in the state of S11, the positions of the cores C₂ to C₇ may be shifted in the rotational direction. That is, in the case that the multi-core optical fibers are connected to each other, the axes of the peripheral cores may not coincide with each other even the center cores (cores C₁) coincide with each other.

Therefore, after S11 is performed, the position adjustment of the multi-core optical fibers 1 is performed (S12).

Here, the second resin unit 22b in the example of the embodiment is formed in an annular form similarly to the first embodiment. Therefore, in the rotational direction, the position adjustment of the connecting member 20 with the multi-core optical fibers 1 is not required. That is, the position adjustment of the multi-core optical fibers is simply required to be performed.

After that, in the state that the position adjustment is done, the multi-core optical fibers are fixed by the adapters (not shown) or the like. The connection between the multi-core optical fibers is established by this fixing.

### [Operations and Effects]

Operations and effects of the embodiment are described.

The plurality of the cores Cₖ of the connecting member 20 according to the embodiment is covered with the clad 2. Also, the connecting member 20 is arranged between the spherically polished end surface of the first multi-core optical fiber and the plane polished end surface of the second multi-core optical fiber. The connecting member 20 has the first resin unit 22a and the second resin unit 22b. On the first surface Fa1 of the core abutting portion 22, the protruding height of the second resin unit 22b in the thickness direction of the connecting member 20 is formed higher than that of the first resin unit 22a. Whereas, on the second surface Fs2, the second resin unit 22b is formed to have the same thickness as that of the first resin unit 22a.

The first surface Fa1 of the first resin unit 22a is in contact with the first core (core C₁) of the first multi-core optical fiber (see FIG. 2D). The second surface Fa2 of the first resin unit 22a is in contact with the first core (core C₁) of the second multi-core optical fiber (see FIG. 11A). Further, light from the first core (core C₁) of one of the multi-core optical fibers is guided to the first core (core C₁) of the other through the first resin unit 22a. The second resin unit 22b is arranged on both of the surfaces in an annular form so as to surround the first resin unit 22a. The first surface Fa1 of the second resin unit 22b is in contact with the second core (cores C₂ to C₇) of the first multi-core optical fiber. The second surface Fa2 of the second resin unit 22b is in contact with the second core (cores C₂ to C₇) of the second multi-core optical fiber. Light from the second core (for example, the core C₂) of one of the multi-core optical fibers is then guided to the second core (for example, the core C₂) of the other through the second resin unit 22b.

As described above, in the fourth embodiment, the connecting member 20 has the first resin unit 22a and the second resin unit 22b having the different thicknesses on one surface and the same thickness on the other surface, according to the shapes of the end surfaces of the multi-core optical fibers which have been subjected to different polishing treatments. It is therefore possible to connect the multi-core optical fibers, which have been subjected to different polishing treatments, to each other without fail. Further, the position adjustment of the multi-core optical fibers with the connecting member 20 in the rotational direction becomes unnecessary by configuring the second resin unit 22b in an annular form. That is, with the use of the connecting member 20 in the embodiment, it is possible to easily establish the connection, and reduce the light connection loss at the time of the multi-core optical fiber connection.

### EXPLANATION OF SYMBOLS

1 MULTI-CORE OPTICAL FIBER
1 END SURFACE
2 CLAD
2a END SURFACE
11 FERRULE
11a, 11b SPACE
11c TAPERED SURFACE
11d END SURFACE
11e FLANGE UNIT
20 CONNECTING MEMBER
21 CONNECTING UNIT
22 CORE ABUTTING PORTION
22a FIRST RESIN UNIT
22b SECOND RESIN UNIT
22c GROOVE
23 FLANGE
23a PROTRUDING PORTION
30 SLEEVE
30a INSERTION HOLE
Cₖ CORE
Eₖ END SURFACE

1. A multi-core optical fiber connecting member, comprising:
a first resin unit that is in contact with a first core on an end surface of a first multi-core optical fiber and a first core on an end surface of a second multi-core optical fiber, and that transmits light from the first core of the first multi-core optical fiber therethrough to guide the light to the first core of the second multi-core optical fiber; and
a second resin unit that is in contact with a second core on the end surface of the first multi-core optical fiber and a second core on the end surface of the second multi-core optical fiber, and that transmits light from the second core of the first multi-core optical fiber therethrough to guide the light to the second core of the second multi-core optical fiber, wherein
each of the first resin unit and the second resin unit has a thickness corresponding to a shape of the end surface of each of the first multi-core optical fiber and the second multi-core optical fiber.

2. The multi-core optical fiber connecting member according to claim 1, wherein
the end surface of both the first multi-core optical fiber and the second multi-core optical fiber is processed into a spherical surface, and
the thickness of the first resin unit differs from the thickness of the second resin unit.

3. The multi-core optical fiber connecting member according to claim 2, wherein
in the first multi-core optical fiber and the second multi-core optical fiber, the first core is a single core arranged substantially in a center position, and the second core includes one or more cores arranged in positions different from the center position, and
the thickness of the first resin unit is less than the thickness of the second resin unit.

4. The multi-core optical fiber connecting member according to claim 3, wherein
the second resin unit is formed in an annular form to surround the first resin unit.

5. The multi-core optical fiber connecting member according to claim 3, wherein
the first multi-core optical fiber and the second multi-core fiber each include a plurality of the second cores,
the first resin unit includes a first lens unit in contact with the first core of each of the first multi-core optical fiber and the second multi-core fiber,
the second resin unit includes a plurality of second lens units in equal number to the second cores, and
the second lens units are each in contact with corresponding one of the second cores of each of the first multi-core optical fiber and the second multi-core optical fiber.

6. The multi-core optical fiber connecting member according to claim 5, wherein
the second lens units are arranged on a concentric circle with the first lens unit as center.

7. The multi-core optical fiber connecting member according to claim 1, wherein
the end surface of both the first multi-core optical fiber and the second multi-core optical fiber is processed into a plane, and
the thickness of the first resin unit is equal to the thickness of the second resin unit.

8. A connecting structure of multi-core optical fibers, comprising:
the first multi-core optical fiber and the second multi-core optical fiber according to claim 1;
a ferrule in which the first multi-core optical fiber and the second multi-core optical fiber according to claim 1 are inserted;
a sleeve in which the ferrule is inserted; and
the multi-core optical fiber connecting member according to claim 1, wherein
the sleeve includes an insertion hole in which the multi-core optical fiber connecting member is inserted in a direction orthogonal to each of insertion directions of the first multi-core optical fiber and the second multi-core optical fiber.

9. A connection method of multi-core optical fibers, comprising:
an arrangement step for arranging the multi-core optical fiber connecting member according to claim 1 in an insertion hole of a sleeve provided in a direction orthogonal to each of insertion directions of a first multi-core optical fiber and a second multi-core optical fiber;
a connection step for inserting the first multi-core optical fiber and the second multi-core optical fiber each inserted in a ferrule from both ends of the sleeve, and connecting the multi-core optical fibers to each other through the multi-core optical fiber connecting member; and
a position adjustment step for adjusting positions of the multi-core optical fibers.

10. A connection method of multi-core optical fibers, comprising:
an arrangement step for arranging the multi-core optical fiber connecting member according to claim 1 in an insertion hole of a sleeve provided in a direction orthogonal to each of insertion directions of a first multi-core optical fiber and a second multi-core optical fiber;
a connection step for inserting the first multi-core optical fiber and the second multi-core optical fiber each inserted in a ferrule from both ends of the sleeve, and connecting the multi-core optical fibers to each other through the multi-core optical fiber connecting member;
a first position adjustment step for adjusting positions of the first multi-core optical fiber and the multi-core optical fiber connecting member; and
a second position adjustment step for adjusting positions of the second multi-core optical fiber and the multi-core optical fiber connecting member.
